(19) United States
(12) Patent Application Publication
(10) Pub. No.: US 2005/0207382 A1
(43) Pub. Date: Sep. 22, 2005

(54) Home agent, mobile communications system, and load dispersing method

(76) Inventors: Akira Hirashima, Osaka (JP); Katsuya Hirasaki, Osaka (JP); Katsuaki Oonishi, Osaka (JP); Hideya Toyama, Osaka (JP)

Correspondence Address: Katten Muchin Zavis Rosenman;IP Department, 575 Madison Avenue, New York, NY, 10022-2585, US

(21) Appl. No.: 11/137,172

(22) Filed: May 25, 2005

Related U.S. Application Data
(63) Continuation of application No. PCT/JP03/06213, filed on May 19, 2003.

(51) Int. Cl. H04Q 7/24

(52) U.S. Cl. 370/338

(57) ABSTRACT

In a mobile communications system in which dynamic IP addresses are assigned, a plurality of home agents are provided. A first home agent of the home agents includes a first holding section having a plurality of regional BCs each of which holds binding data and a plurality of transferred states. The first home agent further includes a selecting section for selecting a second home agent from the plural home agents and also selecting a regional BC for transfer from the plural regional BCs based on first load information and binding cache load information. The first home agent further includes a transmitter section for transmitting the regional BC for transfer toward the second home agent and also transmitting a registered destination change notification toward the mobile node. In addition, network reliability is enhanced while maintaining load dispersion and the performance of each home agent.

### BACKGROUND OF THE INVENTION

(1) Field of the Invention

The present invention relates to home agents, mobile communications systems, and load dispersing methods that are suited for use in Internet protocol (IP) networks employing a mobile IP for assigning IP addresses to mobile nodes dynamically and managing those addresses.

(2) Description of Related Art

With the development of the mobile communications technology, communication services have been widely provided in which users have access to IP networks through mobile nodes (MNs) such as cellular terminals, notebook-sized personal computers (PCs), etc. In the case where stationary workstations and PCs are connected with IP networks, points with access to IP networks are fixed and IP addresses are also assigned fixedly. In contrast with this, MNs have access to IP networks at a plurality of different points.

For that reason, a variety of mobile IPs are prescribed to assign addresses to MNs. The mobile IPs assign addresses to MNs dynamically and also assign an address so that the depletion thereof does not occur.

Here, the reason why a protocol of assigning addresses dynamically is needed is that, if an MN is registered in a home agent provided in a subnetwork and is then moved to another subnetwork, the MN cannot make a connection with the first subnetwork any longer.

The second reason is that it is demanded that stationary nodes, such as PCs, can communicate with a particular MN.

Note that various IPs for mobile communications have been investigated and standardized. For example, there is a mobile Internet protocol version 4 (IPv4).

To avoid the depletion of an address, mobile IPs need to assign a long address. For this reason, mobile IPs have been investigated on the basis of an Internet protocol version 6 (IPv6).

Here, the IPv6 uses hierarchical addresses 128 bits long. More specifically, a hierarchical address is divided into a network prefix field (64 bits) and a host identifier field (64 bits).

And the IPv6 adopts the hierarchical addresses so that in IPv6 networks, continuous communications can be performed according to the movement of each mobile node. For instance, basic specifications for mobile IPs are prescribed by Internet Engineering TaskForce (IETF) (see, for example, non-patent document 1 (IP Mobility Support (Mobile IP) http://www.ietf.org/rfc/rfc2002.txt) and non-patent document 2 (Mobile IPv6 http://www.ietf.org/internet-drafts/draft-ietf-mobile ip-ipv6-19.txt).

For that reason, the mobile IPv6 prescribes home agents for managing the movement of each MN. Each home agent holds (stores, records, or registers) a care-of address (CoA) for transmitting and receiving IP packets at a destination where an MN is moved.

FIG. 15 shows a prior art mobile communications system. The mobile communications system 400 shown in the figure includes an IP network 60, subnetworks 61 to 64 (domains 1 to 5), and a plurality of routers 65 for connecting the IP network 60 with the subnetworks 61 to 64. Mobile nodes (MNs) #1 to #3 belonging to the subnetworks 61 to 64 are in mobile communication with each other through the routers 65 and IP network 60.

Among the subnetworks 61 to 64, the subnetwork 61 is called a home subnetwork to which the MNs #1 to #3 are usually connected. This subnetwork 61 is provided with n home agents 72a, 72b, . . . , and 72c (where n is a natural number ≧2) for holding the respective care-of addresses b, c, and d of the MNs #1 to #3.

Here, the care-of addresses b, c, and d of the MNs #1 to #3 are held in the home agent 72a as a binding cache (BC) by which those addresses are bound to the home address.

An overview of a home address and a care-of address will be given. The home address is an address in a home network where the MNs #1 to #3 are originally present. For example, it is an address in the network 61 shown in FIG. 15. An example of the home address is 100::10. The 100 and 10 represent a network prefix and a host ID, respectively.

The care-of addresses b, c, and d are addresses where the MNs #1 to #3 use in destination networks where they are moved. For instance, if the MN #1 moves to the subnetwork 62, it uses a care-of address b.

When the MN #3 transmits packets to the MN #1 moved to the subnetwork 62, the MN #3 transmits packets to the home address of the MN #1. Since the MN #3 does not know that the MN #1 has moved, the MN #3 operates, assuming the MN #1 is in the subnetwork 61. And the home agent 72a intercepts the packets transmitted from the MN #3. The home agent 72a retrieves a binding cache holding the MN #1 and extracts the care-of address of the destination of the MN #1. And the home agent 72 encapsulates the intercepted packets and transmits the encapsulated packets to the extracted care-of address.

FIG. 16 is a block diagram showing the principal part of the prior art home agent. The home agent 72a shown in the figure includes a transmitter-receiver section 90 (which comprises a transmitter section and a receiver section), a reception processing section 91, a data holding section 300, and a main control section 111. The home agents 72b to 72c are the same in structure as the home agent 72a.

Here, if the reception processing section 91 receives a location registration request message (binding update message) transmitted from the MN #1, it processes that message. The reception processing section 91 has a BC generating section 91 for generating a binding cache (BC) 001.

And the MN #1 registers the care-of address thereof in the home agent 72a. If the MN #1 moves from the subnetwork 61 (see FIG. 15) to the subnetwork 62, it transmits a new care-of address b1 to the home agent 72a again. The home agent 72a writes the new care-of address b1 to the BC 001.

More specifically, if the care-of address of each of the MNs #1 to #3 is changed, the care-of address b is overwritten by the care-of address b1. For example, if the corresponding relationship between a home address H and a care-of address b is changed to the corresponding relationship between a home address H and a care-of address b1, the data image held in the BC 001 is changed from “H+b” to “H+b1.”

Also, if the MN #3 or stationary terminal 64a in the subnetwork 64 transmits a packet having the home address of the MN #1 to the home agent 72a, the home agent 72a intercepts that packet and retrieves the BC 001 and extracts the care-of address b1. The intercepted packet has the care-of address b written to the IP header shown in FIG. 18A. And the home agent 72a attaches the care-of address b1 of the destination of the MN #1 to the IP header. The care-of address b1 attached to the IP header is shown in FIG. 18B. The home agent 72a tunnels the packet shown in FIG. 18B into the subnetwork 62. In this manner, the communication between the MNs #1 and #3 is started and mail data are transmitted and received.

Therefore, the MN #3 does not need to know the care-of address of a destination where the MN #1 is moved. All that is required is to know only the home address of the MN #1. In other words, the home agent 72a functions as a router provided in the home network (subnetwork) 61.

Since the MNs #2 AND #3 use the same communications method as that of the MN #1, the same may be said of them.

Thus, even if each of the MNs #1 to #3 moves from the home network 61 to the subnetwork 62, the MNs #1 to #3 can communicate with each other by the relay function of the home agent 72a.

Also, in coping with an increase in the number of subscribers, a communication carrier can increase the number of home agents for managing a plurality of MNs #1 to #3.

Furthermore, MN-related routers, connected to a network in which both the mobile IPv4 and the mobile IPv6 operate, have been provided (e.g., see patent document 1 (Japanese Laid-Open Patent Publication No. 2002-368790)).

The MN-related routers disclosed in the aforementioned patent document 1 prevent packet delay and packet discard that can be the cause of the communication quality degradation of MNs, by shortening the processing time of the encapsulation of packets addressed to MNs and processing time of mobile IP messages related to MNs.

However, even when the number of home agents is increased, there is still a possibility that location registrations will concentrate in a particular home agent 72a. The reason for that is that location registrations are performed by the MNs #1 to #3 and that the MNs #1 to #3 determine a destination where locations are registered.

More specifically, if a particular home agent 72a of n home agents starts location registrations, the location-registering process is performed between the home agent 72a and the MNs #1 to #3.

Here, in addition to a method of assigning a home address to each of the MNs #1 to #3 fixedly, it can also be automatically assigned to each of the MNs #1 to #3 by a dynamic host configuration protocol (DHCP) server that automatically assigns an address to an MN having a DHCP function.

A care-of address is assigned to each of the MNs #1 to #3 by a foreign agent provided in a destination network. In the case of IPv6, each of the MNs #1 to #3 can also generate a care-of address automatically.

Furthermore, the process of registering a location is the process of registering a care-of address and a home address transmitted from the MNs #1 to #3 as a binding cache (BC). Also, a care-of address and a home address are not frequently transmitted. Therefore, even in the case where a great number of calls concentrate temporarily in the home agent 72a, a load due to that concentration is not great.

In other words, the cause of an increase in a load on the home agent 72a is not the location-registering process, but that when a packet quantity to be transmitted to the MNs #1 to #3 increases with location registrations concentrating in the same home agent, the process of intercepting and tunneling packets by that home agent increases. This load concentration can cause packet-processing delay and packet loss.

FIG. 17 is a diagram for explaining the state in which packet transfer loads concentrate locally. When a plurality of MNs #1 to #3 are simultaneously connected to the home agent 72a provided in the subnetwork 61 shown in the figure, and when a packet transfer quantity to the MNs #1 to #3 increases with location registrations concentrating in the same home agent, the process of intercepting and tunneling packets by the home agent 72a increases. Therefore, an increase in the process exceeds the processing capability of the home agent 72a and can be the cause of packet-processing delay and packet loss.

In the technique disclosed in the aforementioned patent document 1, when a correspondent node (CN) transmits packets to a mobile node (MN), the packets must pass through a home agent in which that mobile node is registered and must be encapsulated in that home agent. Thus, there are cases where a load on a home agent rises.

### SUMMARY OF THE INVENTION

The present invention has been made in view of the aforementioned drawbacks. Accordingly, it is an object of the present invention to provide a home agent, a mobile communications system, and a load dispersing method that are capable of realizing effective resource utilization and low cost in an IP network where a plurality of home agents are provided. Another object of the invention is to provide a home agent, a mobile communications system, and a load dispersing method that are capable of enhancing network reliability while maintaining load dispersion and the performance of the home agent.

To achieve the objects of the present invention, a first home agent of the present invention is a first home agent of a plurality of home agents each for intercepting a first packet with a home address representative of the home of a mobile node and transferring toward the mobile node a second packet with a care-of address associated with the home address. The first home agent comprises three major sections: (1) a first holding section having a plurality of regional BCs each of which holds binding data, the binding data defining a correspondence between a plurality of conversion data pieces, each of which is obtained by converting the home address into the care-of address, and a plurality of transferred states, each of which represents a processed state of each of the conversion data pieces; (2) a selecting section for selecting a second home agent from the plural home agents and also selecting a regional BC for transfer from the plural regional BCs based on first load information, the first load information comprising home agent load information, which is information regarding the load of the first home agent itself, and binding cache load information, which is information regarding the load arising when a tunneling process is performed by using a binding cache; and (3) a transmitter section for transmitting the regional BC for transfer, selected in the selecting section, toward the second home agent and also transmitting a registered destination change notification toward the mobile node.

In this manner, the processing capability of the home agent is used up to the maximum and effective resource utilization is achieved. Thus, the mobile communications system can be realized at low cost.

In the first home agent of the present invention, the aforementioned selecting section preferably has a binding cache selection control section for selecting the regional BC for transfer based on the binding cache load information; and a home agent selection control section for selecting the second home agent. In this manner, load concentration in a particular home agent is avoided and network reliability is enhanced.

It is also preferable that the aforementioned binding cache selection control section is operable to select the regional BC for transfer based on a history of packet transmission quantities calculated when the second packet is being tunneled to the mobile node. In this manner, in doing maintenance, operation becomes possible with a particular home agent stopped. Thus, maintenance becomes easy.

Also preferably, the aforementioned home agent selection control section is operable to use the home agent load information for monitoring an increase in a load on a self-agent, for judging whether a binding cache acceptance request signal is acceptable or unacceptable when it is received, and for calculating acceptable binding cache load information. It is also preferable that the aforementioned home agent selection control section is operable to select the second home agent based on a return signal transmitted from the second home agent toward the first home agent in response to a dispersion process request transmitted by the first home agent, which request contains the regional BC for transfer. In this manner, load concentration in a particular home agent is avoided and network reliability is enhanced. In addition, maintenance becomes easy with a particular home agent stopped.

The aforementioned first holding section preferably includes at least: a state of “under transfer”, which designates the state where the first home agent is transmitting the conversion data pieces toward the second home agent; a state of “under reception”, which designates the state where the second home agent is holding the conversion data pieces; a state of “after transmission”, which designates the state where the first home agent receives completion of reception from the second home agent; and a normal state. In this manner, when a home agent for a mobile node (MN) is switched to another home agent, the communication shut-off time between a correspondent node and an MN is suppressed.

A second home agent of the present invention is a second home agent of a plurality of home agents each for intercepting a first packet with a home address representative of the home of a mobile node and transferring toward the mobile node a second packet with a care-of address associated with the home address. The second home agent comprises three major sections: (1) a collecting section for collecting second load information, the second load information comprising home agent load information, which is information regarding the load of the second home agent itself, and binding cache load information, which is information regarding the load arising when a tunneling process is performed by using a binding cache; (2) a receiver section for receiving a dispersion process request to process conversion data transmitted from a first home agent of the plural home agents; and (3) a judging section for judging whether the dispersion process request is acceptable, based on both first load information, which is contained in the dispersion process request received in the receiver section, and the second load information, which is collected by the collecting section.

In this manner, effective utilization of resources such as memory in each home agent can be achieved and low cost can be realized.

In the second home agent of the present invention, the aforementioned collecting section preferably has a data holding section for holding the second load information. The aforementioned judging section may be operable to judge whether the dispersion process request is acceptable, based on the second load information held in the data holding section. In this manner, when a home agent is switched to another home agent, communication shut-off is avoided.

It is also preferable that when the dispersion process request received by the receiver section has high priority, the aforementioned judging section is operable to calculate an acceptable packet transfer quantity based on the binding cache load information. In this manner, each home agent can take a countermeasure in case of necessity, judge by self-diagnosis that operation is unstable, and assure reliable communications.

A third home agent of the present invention is a third home agent of a plurality of home agents each for intercepting a first packet with a home address representative of the home of a mobile node and transferring toward the mobile node a second packet with a care-of address associated with the home address. The third home agent comprises six major sections: (1) a first holding section having a plurality of regional BCs each of which holds binding data, the binding data defining a correspondence between a plurality of conversion data pieces, each of which is used for converting the home address and the care-of address, and a plurality of transferred states, each of which represents a processed state of each of the conversion data pieces; (2) a receiver section for receiving a dispersion process request for processing the conversion data transmitted from a first home agent of the plural home agents; (3) a collecting section for collecting second load information, the second load information comprising home agent load information, which is information regarding the load of a second home agent of the plural home agents, and binding cache load information, which is information regarding the load arising when a tunneling process is performed by using a binding cache; (4) a selecting section for selecting the second home agent from the plural home agents and selecting a regional BC for transfer from the plural regional BCs, based on first load information comprising home agent load information, which is information regarding the load of the first home agent itself, and binding cache load information, which is information regarding the load arising when a tunneling process is carried out using a binding cache; (5) a judging section for judging whether the dispersion process request is acceptable, based on the first load information, which is contained in the dispersion process request received by the receiver section, and the second load information, which is collected by the collecting section; and (6) a transmitter section for transmitting the regional BC for transfer, selected in the selecting section, toward the second home agent and also transmitting a registered destination change notification to the mobile node.

In this manner, in selecting a home agent for a mobile node, each of the home agents can flexibly select a destination home agent, depending on a load on the destination home agent.

And in accordance with the present invention, there is provided a first home agent for intercepting a first packet with a home address representative of the home of a mobile node and transferring toward the mobile node a second packet with a care-of address associated with the home address. This home agent comprises three major sections: (1) a receiver section for transmitting packets toward, and receiving packets from, the mobile node or a second home agent by using a plurality of conversion data pieces, which is used for converting the home address and the care-of address; (2) a first holding section having a plurality of regional BCs, each of which defines a correspondence between the plural conversion data pieces and a plurality of transferred states, each of which represents a processed state of each of the conversion data pieces; and (3) a dispersion process accepting section for accepting a plurality of regional BCs requested by the second home agent, based on first load information, which is information regarding the load of the first home agent itself, and second load information, which is information regarding the load of the second home agent.

In this manner, a particular home agent is preventing from failing due to an increase in a load thereon, and a stable communication environment is assured.

The aforementioned each of the first home agent and the second home agent preferably includes a transmitter section for controlling packet transfer by changing the transferred state while holding binding data held in the plural regional BCs. In this manner, a possibility of the communication shut-off time between a correspondent node and a mobile node, which arises when a home agent for the mobile node is switched to another home agent, is suppressed.

A mobile communications system of the present invention is a mobile communications system comprising a plurality of home agents each for intercepting a first packet with a home address representative of the home of a mobile node and transferring a second packet toward the mobile node with a care-of address associated with the home address. In the mobile communications system, a first home agent of the plurality of home agents comprises three major sections: (1) a first holding section having a plurality of regional BCs that hold binding data by which a plurality of conversion data for converting the home address and the care-of address are bound to a plurality of transferred states representative of a processed state of each conversion data; (2) a selecting section for selecting both a second home agent of the plurality of home agents and a regional BC for transfer of the plural regional BCs, based on first load information, the first load information comprising home agent load information, which is information regarding the load of the first home agent itself, and binding cache load information, which is information regarding the load arising when a tunneling process is carried out using a binding cache; and (3) a transmitter section for transmitting the regional BC for transfer, selected in the selecting section, toward the second home agent and also transmitting a registered destination change notification to the mobile node. In the mobile communications system, the second home agent of the plurality of home agents comprises three major sections: (1) a collecting section for collecting second load information comprising home agent load information of the second home agent itself and binding cache load information arising when a tunneling process is performed by using a binding cache; (2) a receiver section for receiving a dispersion process request for processing the conversion data transmitted from the first home agent of the plurality of home agents; and (3) a judging section for judging whether the dispersion process request is acceptable, based on the first load information, which is contained in the dispersion process request received by the receiver section, and the second load information, which is collected by the collecting section.

In this manner, when a plurality of home agents are provided, each home agent can disperse a load autonomously. In addition, the processing capability of each home agent can be used up to the maximum.

A load dispersing method of the present invention is a method of dispersing a load between a plurality of home agents each for intercepting a first packet with a home address representative of the home of a mobile node and transferring to the mobile node a second packet with a care-of address associated with the home address.

The load dispersing method comprises, in a first home agent of the plurality of home agents, an excess detection step, carried out by a first judging section, of detecting an excess of the home agent load information of the first home agent over an acceptable quantity; a selection step, carried out by a selection section when the excess is detected in the excess detection step, of selecting a second home agent from the plural home agents and selecting a regional BC for transfer from a plurality of regional BCs each of which holds binding data, based on first load information, the first load information comprising home agent load information, which is information regarding the load of the first home agent itself, and binding cache load information, which is information regarding the load arising when a tunneling process is carried out using a binding cache; and a transmission step, carried out by a first home agent selection control section, of transmitting an acceptance request signal to the second home agent.

The load dispersing method comprises, in the second home agent, an extraction step, carried out by a second home agent selection control section, of extracting binding cache load information for transfer from the acceptance request transmitted in the transmission step; an acceptance judgment step, carried out by a second judging section, of judging acceptance based on the extracted binding cache load information and the home agent load information of the first home agent; and a response signal transmission step, carried out by the second home agent selection when the judgment in the acceptance judgment step is “acceptable”, of transmitting a binding cache acceptance response signal to the first home agent.

And the load dispersing method comprises, in the first home agent, a transfer step, carried out by the first home agent control selection when the binding cache acceptance response signal transmitted in the response signal transmission step is received, of transferring a binding cache to the second home agent.

Therefore, when a great number of calls concentrate temporarily in a particular home agent, that home agent previously recognizes that a load thereon exceeds the BC processing capability thereof, and transfers a binding cache (BC). Thus, load concentration in a home agent is avoided.

Also, the load dispersing method comprises, in the first home agent, a state set step, carried out by a transmission control section, of transferring a binding cache transmission signal to the second home agent and setting each state of each binding cache for transfer. The load dispersing method comprises, in the second home agent, a state change step, carried out by a reception control section, of registering a transfer binding cache contained in a binding cache transmission signal and changing a state of the transfer binding cache to one state of a plurality of states of the transfer binding cache, and a response signal transmission step of transmitting a binding cache acceptance response signal to the first home agent. The load dispersing method comprises, in first home agent, a response signal reception step, carried out by the transmission control section, of receiving the binding cache acceptance response signal and a deletion step of deleting one or a plurality of transfer binding caches. And the load dispersing method comprises, in the second home agent, a response reception step, carried out by the reception control section, of receiving a confirmation response for the deletion performed in the deletion step. In this manner, load concentration is avoided, whereby packet-processing delay and packet loss are prevented.

### BRIEF DESCRIPTION OF THE DRAWINGS

FIG. 1 is a diagram showing a mobile communications system constructed according to an embodiment of the present invention;

FIG. 2 is a block diagram showing the home agent of the embodiment of the present invention;

FIG. 3 is a diagram for explaining generation of HA load information and a load judgment process according to the embodiment of the present invention;

FIG. 4 is a diagram for explaining the process of collecting BC load information according to the embodiment of the present invention;

FIG. 5 is a diagram for explaining the process of judging acceptance of a binding cache according to the embodiment of the present invention;

FIG. 6 is a diagram for explaining an urgent acceptance judgment process according to the embodiment of the present invention;

FIG. 7A is a diagram for explaining the region of a binding cache 001 according to the embodiment of the present invention;

FIG. 7B is a diagram showing an example of the data held in BC load information according to the embodiment of the present invention;

FIG. 7C is a diagram showing an example of the data held in home agent load information according to the embodiment of the present invention;

FIG. 8A is a diagram showing the format of a BC acceptance request signal according to the embodiment of the present invention;

FIG. 8B is a diagram showing the format of an urgent BC acceptance request signal according to the embodiment of the present invention;

FIGS. 9A and 9B are diagrams showing the formats of a BC acceptance response signal according to the embodiment of the present invention;

FIG. 9C is a diagram showing the format of an urgent BC acceptance response signal according to the embodiment of the present invention;

FIG. 10A is a diagram showing the format of a BC transmission signal according to the embodiment of the present invention;

FIG. 10B is a diagram showing the format of a BC reception confirmation signal according to the embodiment of the present invention;

FIG. 10C is a diagram showing the format of a BC deletion notification signal according to the embodiment of the present invention;

FIG. 10D is a diagram showing the format of a BC transfer completion signal according to the embodiment of the present invention;

FIG. 11 is a flowchart for explaining a BC selection control method, according to the embodiment of the present, which is carried out when there are destination home agents;

FIG. 12 is a flowchart for explaining a BC selection control method, according to the embodiment of the present, which is carried out when there is no destination home agent;

FIG. 13 is a flowchart for explaining a BC selection control method, according to the embodiment of the present, which is carried out in case of necessity;

FIG. 14 is a flowchart for explaining the process of transferring a binding cache 001 after the determination of a destination home agent according to the embodiment of the present invention;

FIG. 15 is a diagram showing a prior art mobile communications system;

FIG. 16 is a block diagram showing the principal part of the prior art home agent;

FIG. 17 is a diagram for explaining the state in which packet transfer loads concentrate locally;

FIG. 18A is a diagram showing the format of a received packet;

FIG. 18B is a diagram showing the format of a packet having a cared-of address attached to the IP header;

FIG. 19 is a diagram for explaining a method of transferring packets according to a conventional mobile communications system; and

FIG. 20 is a diagram for explaining a method of transferring packets according to the embodiment of the present invention.

### DESCRIPTION OF THE PREFERRED EMBODIMENTS

Embodiments of the present invention will hereinafter be described with reference to the drawings.

(A) Explanation of an Embodiment of the Present Invention

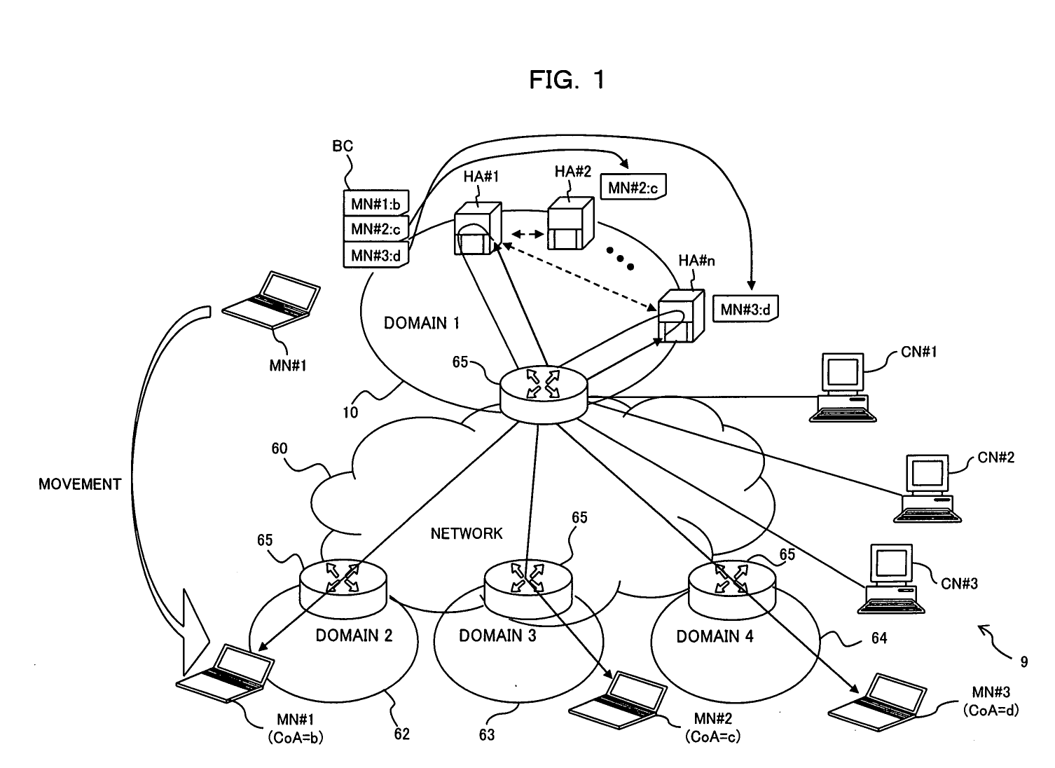

FIG. 1 shows a mobile communications system constructed according to an embodiment of the present invention. The mobile communications system 9 shown in the figure includes n home agents #1 to #n for intercepting packets with a home address representative of the home of mobile nodes (MNs) #1 to #3 and forwarding packets with a care-of address (CoA) related to the home address to the MNs #1 to #3. The mobile communications system 9 further includes correspondent nodes (CNs) #1 to #3, an IP network 60, subnetworks 10 and 62 to 64, MNs #1 to #3, and a plurality of routers 65.

(1) Construction of Mobile Communications System 9

The mobile communications system 9 employs, for example, a mobile Internet protocol version 6 (mobile IPv6) The MNs #1 to #3 are assigned addresses that are not changed for a fixed period of time. The MNs #1 to #3 are assigned addresses that are fixedly placed under a home network.

The location of each of the MNs #1 to #3 is registered in a home agent provided in a home network (e.g., subnetwork 10 to be described later). The MNs #1 to #3 previously have a home address or are assigned a home address by a dynamic host configuration protocol (DHCP) server provided in a subnetwork to which the MNs #1 to #3 were first connected. Also, when the MNs #1 to #3 are assigned a home address by a DHCP server, they belong to a subnetwork to which that DHCP server belongs.

Thus, the MNs #1 to #3 all belong to a home network (e.g., subnetwork 10). In the following description, suppose that the home network of the MNs #1 to #3 is the subnetwork 10.

Note that the locations of the MNs #1 to #3 may be registered in any of the home agents belonging to the home network.

(1-1) Correspondent Nodes #1 to #3

The CNs #1 to #3 are in communication with the MNs #1 to #3 and are host servers provided in enterprises, schools, or government offices; servers provided in communication service providers to be accessed through telephone lines by users; or routers for forwarding packets by employing addresses.

For example, if a user transmits mail data or file data to the MNs #1 to #3 by employing the CN#1, the mail data or file data is forwarded to the subnetwork 10 through the router 65.

(1-2) Subnetworks 10 and 62 to 64

Each of the subnetworks 10 and 62 to 64 is, for example, a private or dedicated network provided in an enterprise or government office, and forwards packets within the subnetwork and retransmits packets to the IP network 60. Each of the subnetworks 10 and 62 to 64 has a plurality of personal computers (PCs), work stations, local area networks, and routers.

(1-3) Subnetwork 10 as a Home Network

The subnetwork 10 functions as the home network of the MNs #1 to #3 and further has the same function as that of each of the subnetworks 62 to 64. Each of the MNs #1 to #3 is assigned an address that is placed fixedly under the home network 10. For example, when a user is in a particular room, or when a user moves within the communication range of the subnetwork 10, the user connects with the subnetwork 10. And this subnetwork 10 has n home agents #1 to #n for holding the care-of addresses b, c, and d of the MNs #1 to #3.

(1-4) Source Home Agent and Destination Home Agent

The home agents #1 to #n are of like construction and function as home agents in a source of transmission (source home agents) and also function as home agents in a destination of transmission (destination home agents).

(1-4-1) Source Home Agent

The data to be actually moved by the home agent #1 is BC data. The movement of a process itself is performed according to movement of the BC data. An example is a conversion from a home address to a care-of address or tunneling process. For instance, for the greater of two loads that the home agent #1 has, the home agent #1 has the function of transmitting a message signal requesting a conversion process (BC process) between a home address and a care-of address (which is a dispersion process request called a BC acceptance request signal) to some or all of the home agents #2 to #n.

To request acceptance of a BC process, the home agent #1 selects any home agent #i of the home agents #2 to #n (where i is a natural number between 2 and n), based on binding cache (BC) load information and home agent (HA) load information. For example, the home agent #1 transmits to the home agent #2 a BC acceptance request signal containing a BC region for transfer.

The home agent #2 judges whether the BC acceptance request signal is acceptable and transmits the result of the judgment to the home agent #1. When a return signal (response signal) from the home agent #2 represents “acceptable,” the home agent #1 selects the home agent #2 as a destination home agent.

If the home agent #1 receives n return signals transmitted from all the home agents #2 to #n, then it extracts a BC region of acceptable size contained in the return signal, compares a load represented by the extracted BC region with the load requested by the home agent #1, and determines a destination home agent. That is, each of the home agents #1 to #n transmits a BC acceptance request signal to the (n-1) home agents other than itself and, based on the responses transmitted from the (n-1) home agents, selects a destination home agent.

(1-4-2) Destination Home Agent

On the other hand, the home agents #1 to #n are all operable as destination home agents and also have the function of receiving and processing a BC acceptance request signal.

For instance, in response to requests to process a load transmitted from some or all of the home agents #2 to #n, the home agent #1 transmits response messages indicative of “acceptable” or “unacceptable” to the other home agents #2 to #n. More particularly, if the home agent #1 receives BC acceptance request signals from the home agents #2 to #n, then it compares the BC load information (which requests to be processed) contained in the BC acceptance request signals with the HA load information of the home agent #1 itself, and transmits BC acceptance response signals containing a message representative of whether it is operable as a destination home agent, to the home agents #2 to #n. Here, the load information is calculated based on information measured in the home agent (HA) load measuring section (collecting section) 100 of a destination home agent that is to be described.

Thus, the destination home agent #2 transmits to the source home agent #1 the information for selecting a destination home agent.

On the other hand, the home agents #2 to #n each have both functions of a source home agent and a destination home agent.

(1-4-3) Home Agent #2

The home agent #2 includes (1) a transmitter-receiver section 90 for transmitting and receiving packets to and from the MNs #1 to #3 or other home agents, employing a plurality of conversion data for converting a home address and a care-of address; (2) a data holding section (holding section) 300 for having a plurality of BC regions in which a plurality of conversion data held in a BC 001 are related to the processed states of the conversion data; and (3) a dispersion process accepting section 100 for accepting a plurality of BC regions requested from the home agent #2, based on the first load information (002, 003) of the home agent #1 and the second load information (002, 003) of the home agent #2. Here, what is actually accepted is BC data. A dispersion process is accepted according to movement of the BC data.

In the following description, assume that the home agents #1 and #2 function as a source home agent and a destination home agent, respectively.

Thus, in the case where a plurality of home agents #1 to #n are provided, the capability of each of the home agents #1 to #n can be used up to the maximum.

Furthermore, since resources such as memory for each of the home agents #1 to #n can be effectively utilized, costs can be cut down.

(1-4-4) Location Registration

Location registration will be described in the case where the MN #1 moves from the home network 10 to the subnetwork 62.

The MN #1 receives a router advertisement message containing the identification information on the subnetwork 62 from an access router (not shown) having a radio communication function provided in the subnetwork 62, thereby detecting or recognizing the subnetwork 62 where the MN #1 has moved. The router advertisement message is transmitted periodically or in response to a location registration request from the MN #1.

A new care-of address (e.g., b) of the MN #1 is acquired either by generating it with the MN #1 itself or by extracting it from a router advertisement message containing a care-of address b generated by the subnetwork 62.

If the MN #1 recognizes that the subnetwork connected by the MN #1 has been changed, it transmits a location registration request message (binding update message) to the home agent #1. The home agent #1 extracts the care-of address b contained in the location registration request message and holds the care-of address b in a binding cache (BC) 001, whereby the location registration is completed.

Next, if the MN #1 moves from the home network 10 to the subnetwork 62, it sends a message containing a new care-of address b1 to the home agent #1. The home agent #1 updates the care-of address b held in the BC 001 to the new care-of address b1. The home agent #1 also transmits a binding response packet to the MN #1. After receiving the response packet, the MN #1 recognizes the completion of the location registration.

(1-5) Home Agent #1

(1-5-1) Functions of the Home Agent #1

The home agent #1 of the present invention is one of the n home agents #1 to #n that intercept a first packet with a home address representative of the home of the MNs #1 to #3 and transfer a second packet with a care-of address related to the home address to the MNs #1 to #3. This home agent #1 has the function of communicating with the MNs #1 to #3 and the function of transmitting and receiving load information (BC load information and HA load information) to and from other home agents #2 to #n.

As the function of communicating with the MNs #1 to #3, the home agent #1 holds the location registration data of the MNs #1 to #3 (the home address and care-of addresses of the MNs #1 to #3 also called location information) and, based on this location registration data, intercepts packets transmitted from the CNs #1 to #3 (e.g., CN #1) and transfers the intercepted packets to the MNs #1 to #3 (e.g., MN #1).

In addition, the home agent #1 exchanges load information comprising HA load information and BC load information by exchanging messages with other home agents #2 to #n. The home agent #1 transmits the HA load information and BC load information thereof to other home agents #2 to #n and receives the HA load information and BC load information transmitted from each of the other home agents #2 to #n.

The communication data between the home agent #1 and other home agents #2 to #n are information data and control data. The information data is data held in a binding cache (BC). The control data is data containing information on a load on the home agent #1 (load information and load state or status) measured by the home agent #1.

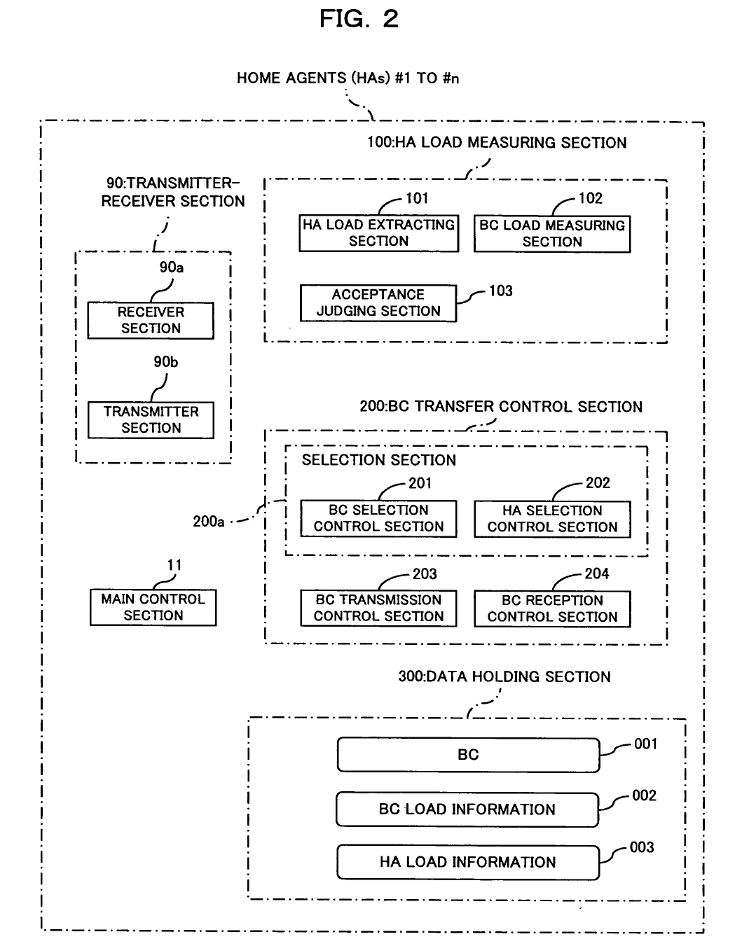

Therefore, in addition to the normal function of communicating with the MNs #1 to #3, the home agent #1 of the present invention can also communicate with other home agents #2 to #n. Note that the construction of the home agent #1 will be described later with reference to FIG. 2.

(1-5-2) Binding Cache (BC) 001

The BC 001 is memory (buffer) for holding the home address and care-of address of each of the MNs #1 to #3 and a validity time of registration and is generated when the home agent #1 receives a binding update (BU) message from the MNs #1 to #3. And when the MN #1 moves to the subnetwork 62 other than the home network 10 after a BC 001 is generated, the MN #1 generates a new care-of address, or acquires a new care-of address transmitted from the subnetwork 62 or from an upper subnetwork of the subnetwork 62. And the MN#1 transmits the new care-of address to the home agent #1. If the home agent #1 receives this care-of address, it updates the care-of address of the MN #1 recorded on the BC 001. Also, after the validity time of the registration of the BC 001, the binding cache for a care-of address is deleted, whereby memory and resources are efficiently utilized.

(1-6) IP Network 60 and Router 65

The IP network 60 is a network for forwarding packets, in which PCs, work stations, network nodes (servers) such as LANs are connected with routers that select an appropriate pathway for packets and route the packets accordingly. The packet format has an information data field and a header field containing a source node address and a destination node address. Packets within the IP network 60 or from an external unit are transmitted to a network node or router in which the address is referred to, and are transmitted to a destination node (MN #1) through a plurality of pathways.

The router 65 is a device for forwarding packets, provided at a point where the IP network 60 is connected with each of the subnetworks 62 to 64, and has a gateway function. For example, the gateway function of the router 65 connected to the subnetwork 10 is the function of forwarding to the IP network 60 only a packet with a preset address received from the subnetwork 10 and also forwarding to the subnetwork 10 only a packet with a preset address received from the IP network 60. Each router 65 preferably has an address table (not shown) and employs a learning table (not shown).

Because the gateway function of the subnetworks 62 to 64 is the same as that of the subnetwork 10, a description of the gateway function is omitted for avoiding redundancy.

(1-7) MNs #1 to #3

Each of the MNs #1 to #3 is a mobile phone or node, which is normally connected to the subnetwork 10 and given a home address. When a user moves to any one of the subnetworks 62 to 64, the MN #1 sends a registration message for registering a care-of address (CoA) to one home agent (e.g., home agent #1) of the home agents #1 to #n of the subnetwork 10.

Note that a mobile IP, such as a mobile IPv4 and a mobile IPv6, prescribes that the same BC data must not exist in a plurality of home agents #1 to #n. The reason is that in an ordinary IP, BC data is generated only when the MNs #1 to #3 send messages to the home agents #1 and #2 and that the MNs #1 to #3 do not transmit BU (binding update) messages to a plurality of home agents #1 and #n.

And if the home agent #1 receives a location registration request message or BU message, it generates a BC 001 and writes the care-of address recorded on the BC 001 to the destination address of the header of a packet transmitted by a source node.

The MNs #1 to #3 each have the function of transmitting and receiving voice or data, the function of generating a new care-of address when handover occurs and immediately holding the old care-of address given immediately before the occurrence of handover, and the function of transmitting a BU message or location registration request message requesting the mobile communications system 9 to transfer a packet addressed to the old care-of address to a new care-of address.

(2) Construction of Home Agent #1

The home agent #1 shown in FIG. 1 manages the care-of addresses of the MNs #1 to #3 and transfers the messages required to transfer the load information of the home agent #1 itself and BC data, to each of the home agents #2 to #n.

The home agents #2 to #n hold and manage the care-of addresses of MNs (not shown) other than the MNs #1 to #3. The detailed construction of the home agents #2 to #n is the same as that of the home agent #1 to be described later.

The location of each of the MNs #1 to #3 can be registered in a home agent of a new network if the home address of the MNs #1 to #3 is placed under the new network. That is, when a home address and a home agent are placed under the same network, the location of each of the MNs #1 to #3 can be registered in a home agent of a new network.

FIG. 2 is a block diagram showing the home agent of the embodiment of the present invention. The home agent shown in the figure includes a main control section 11, a transmitter-receiver section (a transmitter section and a receiver section) 90, a home agent load measuring section (collecting section) 100, a BC transfer control section 200, and a data holding section 300. These functions of the home agent can be realized, for example, by a workstation.

(2-1) Main Control Section 11

The main control section 11 performs the collection or measurement of the load information of the home agent #1 itself, the operation control of modules provided in the home agent #1, the reading and writing of memory data, and the management of input-output interfaces. These functions of the main control section 11 can be realized by a central processing unit (CPU), a read-only memory (ROM), a random access memory (RAM), etc.

(2-2) Transmitter-Receiver Section 90

The transmitter-receiver section 90 transmits and receives packets and has a receiver section 90a and a transmitter section 90b. The receiver section 90a receives a BC acceptance request signal about the processing of conversion data transmitted from the source home agent #1 of the home agents #1 to #n.

The transmitter section 90b transmits regions for transfer selected respectively by a BC selection control section 201 and a HA selection control section 202 to the destination home agent #2 and also transmits a registered destination change message to each of the MNs #1 to #3. Therefore, each of the MNs #1 to #3 can receive packets from CNs #1 to #3 even at a subnetwork where the MN has moved.

Thus, in the receiver section 90a, the reception of a packet, the extraction of data contained in that packet, and the judgment of the packet type are performed. In the transmitter section 90b, a registered location change message with a care-of address is transmitted to the MNs #1 to #3.

The functions of the transmitter-receiver section 90 can be realized by operating the physical input-output ports of a workstation, a transmitter-receiver buffer employed mainly for transmitting and receiving packets, and a software application for operating input-output ports (e.g., a device driver) in cooperation with each other.

(2-3) Home Agent Load Measuring Section 100

The source home agent #1 transmits the BC load information of the home agent #1 itself to the destination home agent #2.

(2-3-1) Measurement of Load Information (Collection of Load Information)

The home agent load measuring section 100 measures second load information comprising HA load information 003 and BC load information 002. The HA load information 003 is the HA load information of the destination home image #2 itself. The BC load information 002 is information generated based on the history of the packet transfer quantities of the binding data held in five BC regions 1 to 5 for holding binding data by which five conversion data for converting a home address and a care-of address are bound to five states representative of the processed states of the five conversion data.

The BC load information 002 is binding cache (BC) load information arising when a tunneling process is performed by using BC data. More specifically, it represents the transfer quantity of packets on which the tunneling process has been performed. The BC load information 002 is employed in judging whether BC data is transferred in a home agent, also in selecting BC data for transfer, and in calculating an acceptable BC transfer quantity.

(2-3-2) Construction of Home Agent Load Measuring Section 100

The home agent load measuring section 100 has the function of attaching a care-of address to the address field of a packet and transferring the packet and measuring a packet transfer quantity of each care-of address recorded on a BC 001 for the transferred packet and the function of judging whether a new recordable region is in the BC 001, in addition to the function of measuring the load information of the home agent #1 itself. This home agent load measuring section 100 includes a home agent load extracting section 101, a BC load measuring section 102, and an acceptance judging section (judging section) 103.

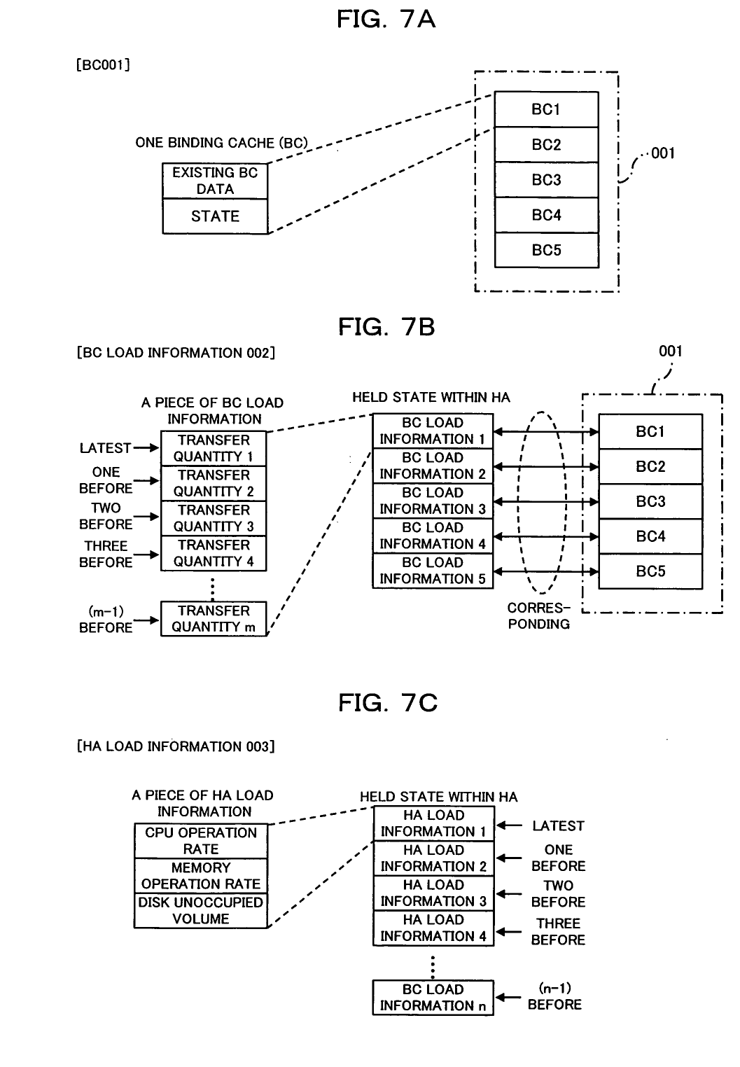

The home agent load extracting section 101 measures and records the load information of the home agent #1. Examples of the load information are a CPU operation rate and an operation rate of all memory devices being operated when transmitter-receiver buffers and workstations are operating (memory activity rate) or an unoccupied volume of a storage device such as a hard disk. The load information is collected by the main control section 11. The main control section 11 performs a load measurement and acceptance judgment of the home agent #1 in cooperation with the home agent load extracting section 101, HA load information 003 (see FIG. 7C to be described later), and acceptance judging section 103.

The CPU operation rate and the memory operation rate or unoccupied volume are measured by employing an application program that monitors the status in which the CPU and memory in a workstation are being used.

The BC load measuring section 102 measures and records a packet transfer quantity for each BC 001.

The acceptance judging section 103 judges whether a BC acceptance request signal is acceptable, based on the first load information (002 and 003) contained in a BC acceptance request signal received by the receiver section 90a and the second load information (002 and 003) collected by the HA load information measuring section 100. Thus, the acceptance judging section 103 functions as a judging section.

The acceptance judging section 103 also judges whether a load on a home agent exceeds an acceptable value, based on a threshold value preset by a maintenance man. And at the time of the judgment, it also calculates an allowable load value for the BC 001 required to process the BC 001.

Therefore, the home agent #1 monitors the load information of the home agent #1 itself at all times and also sends a load information message to the home agents #2 to #5. The load information is inserted into a message relating to BC transfer that is transmitted and received between the home agents #1 to #5. A load on the home agent #1 is dispersed between some or all of the home agents #1 to #5 that can afford to process that load.

(2-4) Generation of HA Load Information and Load Judgment Process

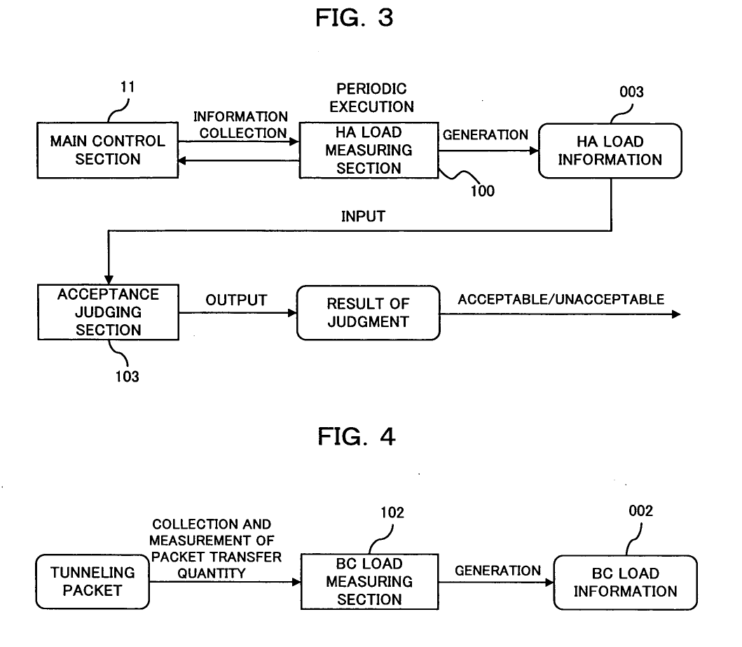

FIG. 3 is a diagram for explaining generation of HA load information and a load judgment process according to the embodiment of the present invention. The home agent load measuring section 101 shown in the figure sends a trigger signal to the main control section 11 periodically. The main control section 11 measures the load information (a CPU operation rate, a memory operation rate, a device unoccupied volume, etc.) of the home agent #1. The main control section 11 writes the measured load information to the data holding section 300, whereby HA load information 003 is generated. The acceptance judging section 103 reads out load information from the data holding section 300, judges the degree of a load on the home agent #1, and outputs the result of the judgment.

Note that the judgment of a load on each of the home agents #2 to #n is nearly the same as that of the home agent #1. Therefore, the load information of each of the home agents #2 to #n is updated periodically. Thus, each of the home agent #1 to #n can have updated load information.

(2-5) BC Load Information

FIG. 4 is a diagram for explaining the process of collecting BC load information according to the embodiment of the present invention. The home agent #1 reads the state of a BC 001 (e.g., see FIG. 7A) held in a packet received. Each state represents the operating state of the home agent #1 in each of the processing stages of collection and transfer. For example, the state of “under transfer” represents the state in which the home agent #1 is about to transfer BC data to another home agent. During this transfer, the BC load measuring section 102 measures a packet transfer quantity and writes the result of the measurement to BC load information 002. The process of collecting the BC load information of each of the home agents #2 to #n is nearly the same as that of the home agent #1.

Thus, during tunneling, a packet transfer quantity is measured as the data of the load information, whereby BC load information 002 is generated.

(2-6) Process of Judging Acceptance of BC 001

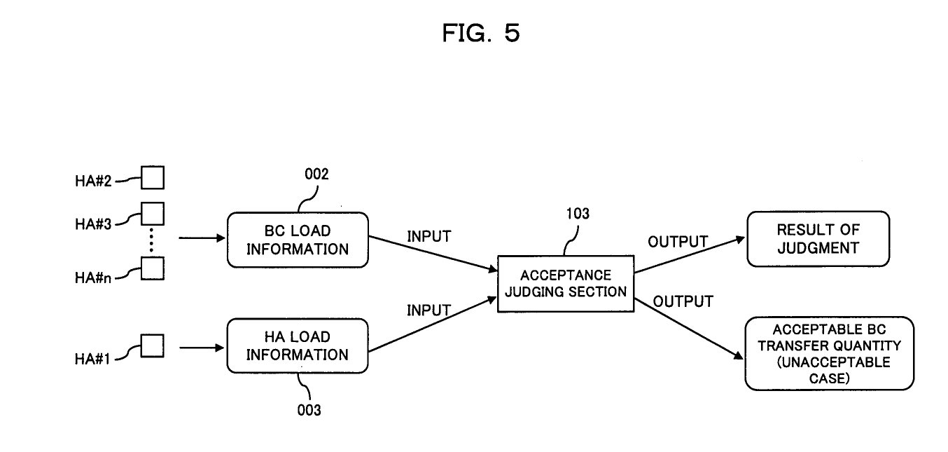

FIG. 5 is a diagram for explaining the process of judging the acceptance of a BC 001 according to the embodiment of the present invention. In the figure, the same parts as the aforementioned parts are given the same reference numerals.

Here, when the HA load selection control section 202 (see FIG. 2) of the home agent #1 receives BC acceptance request signals from other home agents #2 to #n, the acceptance judging section 103 of the home agent #1 judges whether the processing of the requested BC 001 is acceptable, based on the BC load information 002 contained in the BC acceptance request signal transmitted from each of the home agents #2 to #n and on the HA load information 003 of the home agent #1 itself, and outputs the result of the judgment. When the result of the judgment is “unacceptable”, the acceptance judging section 103 of the home agent #1 also calculates an acceptable BC transfer quantity in consideration of a margin.

(2-7) Urgent Acceptance Judgment Process

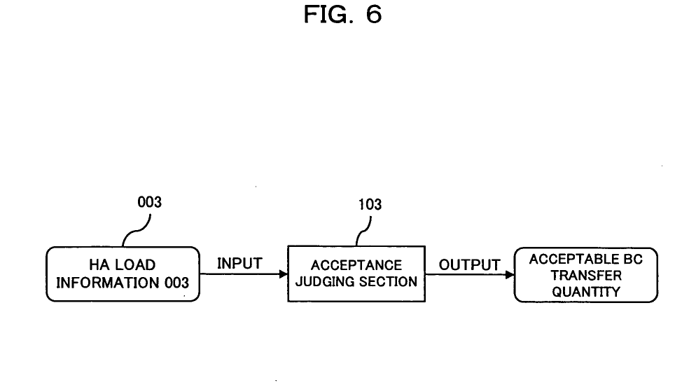

FIG. 6 is a diagram for explaining an urgent acceptance judgment process according to the embodiment of the present invention. If the home agent #1 receives an urgent BC acceptance request signal, it calculates an acceptable BC transfer quantity. More specifically, the acceptance judging section 103 reads data held in the HA load information 003 and, based on this data, calculates the maximum BC transfer quantity (acceptable BC transfer quantity) that the home agent #1 can accept.

In this manner, when each of the the home agents #1 to #3 judges by self-diagnosis that operation is unstable, the home agent can transfer BC data and therefore reliable communications can be assured.

(2-8) BC Transfer Control Section 200 (see FIG. 2)

The BC transfer control section 200 performs various controls for transmitting a BC 001 to other home agents #2 to #n and control for the acceptance of a BC 001 transmitted from the home agents #2 to #n. This BC transfer control section 200 includes a selecting section 200a, a BC transmission control section 203, and a BC reception control section 204. The selecting section 200a comprises a BC selection control section 201 and a HA selection control section 202.

Here, the BC selection control section 201 selects a BC region for transfer, based on BC load information 002. The BC reception control section 204 selects the destination home agent #2, based on HA load information 003. The selecting section 200a will be described in further detail.

(2-9) BC Selection Control Section 201

The BC selection control section 201 selects a BC 001, of five BC 001s for each of the MNs #1 to #3 (see FIG. 7A) managed by the home agent #1, which is to be transferred to other home agents #2 to #n. This selection is performed based on the load information (BC load information 002) and HA load information 003 measured in the home agent measuring section 100.

(2-10) HA Selection Control Section 202

The HA selection control section 202 selects a destination home agent #2 of the home agents #2 to #n to which the selected BC 001 is to be transferred. More specifically, it selects a processable home agent of the home agents #2 to #n. The destination home agent selecting method in the HA selection control section 202 varies between a source HA 500 and a destination HA 501.

(2-11) Selecting Section 200a

The functions of the selecting section 200a are exhibited by causing the BC selection control section 201 and HA selection control section 202 to cooperate with each other.

A source home agent transmits a BC acceptance request to other home agents and, based on the result of the response, determines a destination home agent. The response includes information indicative of “acceptable” or “unacceptable,” or an acceptable BC load limit. And each of the requested home agents refers to the HA load information of itself and judges whether the processing of the requested BC 001 is acceptable.

(2-12) BC Transmission Control Section 203 and BC Reception Control Section 204

The BC transmission control section 203 performs the process of transmitting a BC 001 to the destination home agent #2. For instance, the source home agent #1 first determines a BC 001 for transfer and a destination home agent #2. The source home agent #1 then transmits a BC 001 and transmits and receives the required messages for BC-001 transfer to and from the destination home agent #2. Thereafter, the source home agent #1 changes the state of the BC 001 held by itself and deletes the BC 001.

The BC reception control section 204 receives the BC 001 from the source home agent #1 and transmits and receives the required messages for this reception. The BC reception control section 204 then registers the received BC 001 and changes the state. The home agent sends messages to only one MN relating to the transferred BC, not all the MNs #1 to #3.

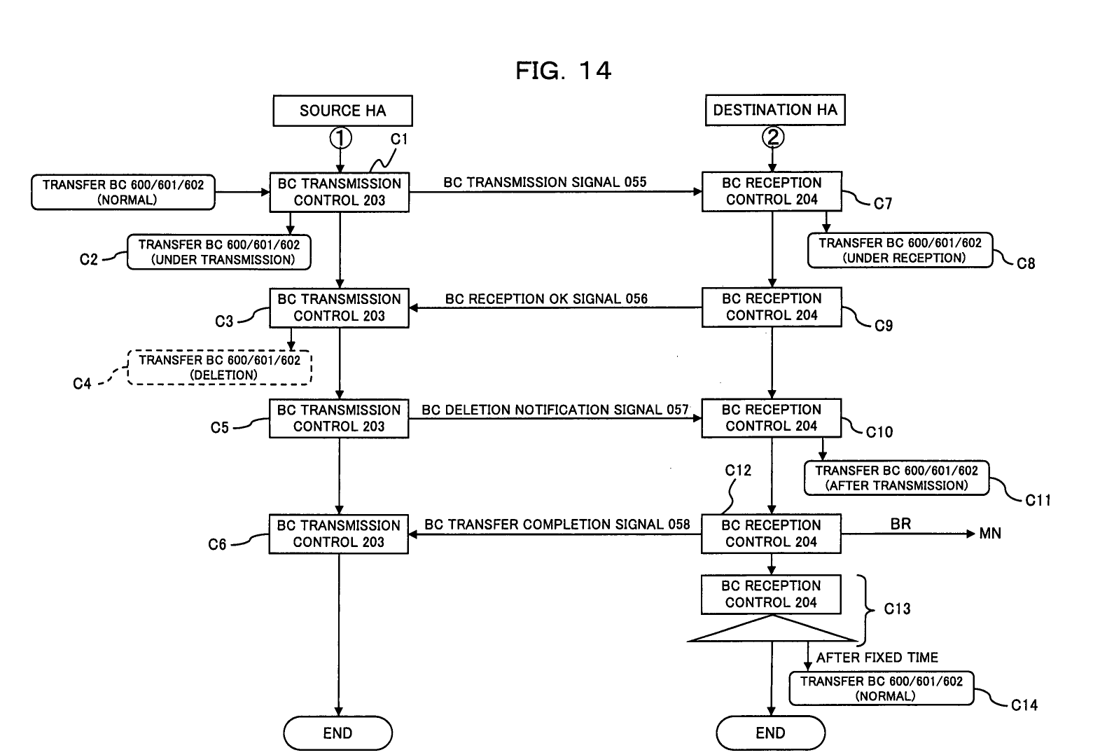

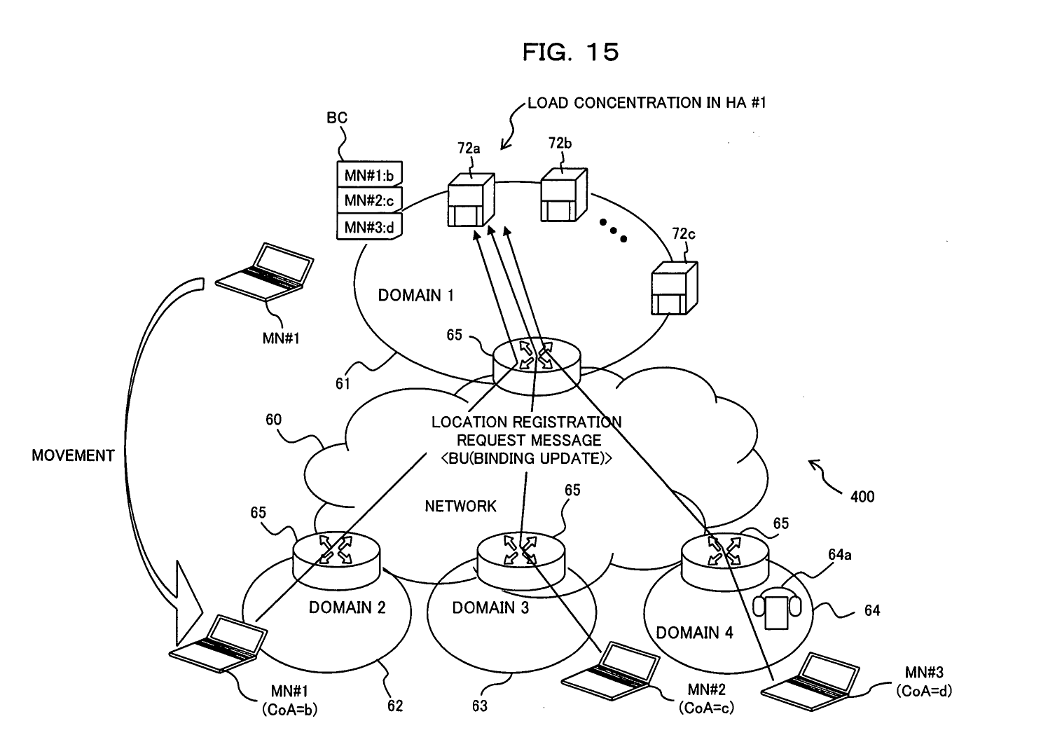

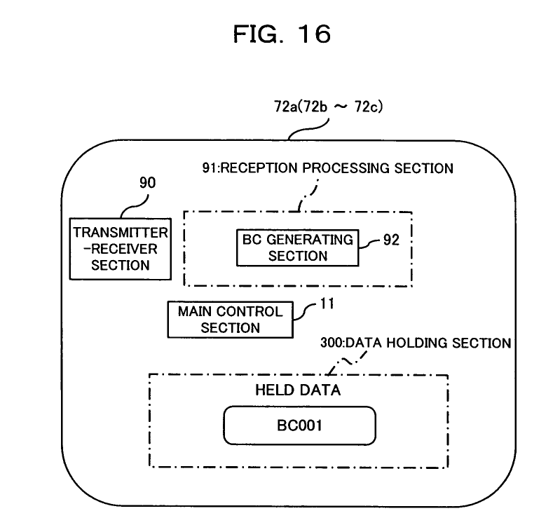

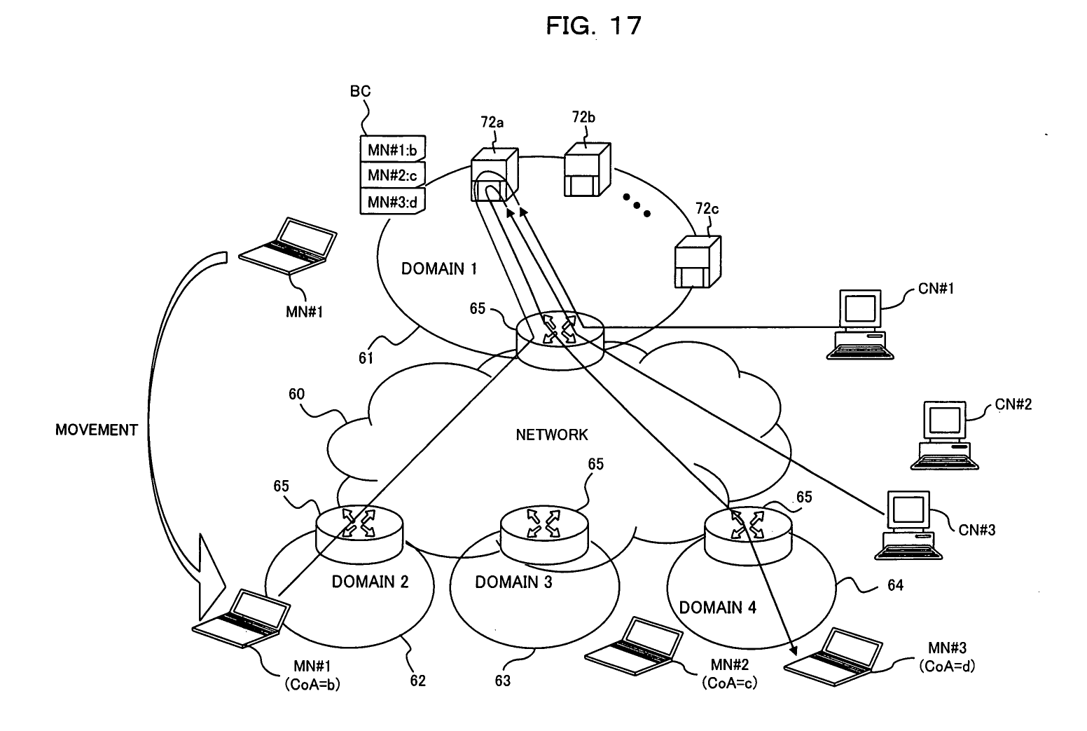

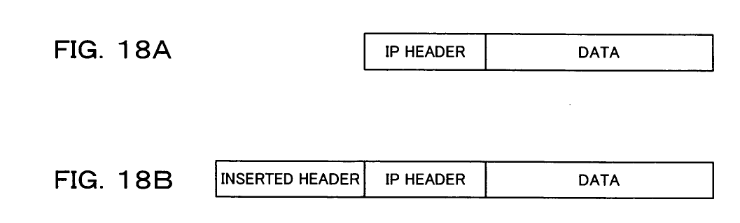

The messages transmitted and received between the BC transmission control section 203 and the BC reception control section 204 are, for example, four kinds of signal messages (BC transmission signal 055, BC reception OK signal 056, BC deletion notification signal 057, and BC transfer completion signal 059) shown in FIG. 14 to be described later. For example, when the source home agent #1 requests the home agent #2 to process a BC 001, a signal that the source home agent #1 first transmits to the destination (candidate) home agent #2 is a BC acceptance request signal 051. If the destination home agent #2 receives this BC acceptance request signal 051, the BC transmission control section 203 transmits a BC transmission signal 055 to the BC reception control section 204 of the destination home agent #2.

Here, if the destination home agent #2 receives this BC transmission signal 055, it judges whether the signal is acceptable or unacceptable, considering the transfer quantity of the BC transmission signal 055 and the magnitude of a load on the destination home agent #2 at that time. If the destination home agent #2 judges that it is unacceptable, the home agent #2 transmits a message representative of “unacceptable” to the source home agent #1.

Even when it is unacceptable, a destination (candidate) home agent sends back an acceptable BC transfer quantity. Therefore, when all candidates are “unacceptable,” there are cases where a BC 001 is changed and reselected.

On the other hand, when the destination home agent #2 judges that it can process the data of the BC transmission signal 055, it transmits a message representative of “acceptable” to the source home agent 1. After the destination home agent #2 responds to the acceptance signal, the source home agent #1 transmits the BC transmission signal 055 and transmits BC data to the destination home agent #2. Note that this BC transmission signal 055 is not transmitted to the MNs #1 to #3.

Therefore, the data of the BC transmission signal 055 to be transmitted to the MNs #1 to #3 is processed in the destination home agent #2. The source home agent #1 holds the same BC transmission signal 055 as the BC data transmitted to the destination home agent #2 with the BC transmission signal 055. And the BC transmission signal 055 becomes unnecessary. The BC transmission system is soley for the purpose of notification or transmission, so what is actually held is only BC data.

For that reason, the source home agent #1 deletes the BC transmission signal 055 when it receives a BC reception OK signal 056 from the destination home agent #2. And if the source home agent #1 receives the BC reception OK signal 056 and deletes the BC transmission signal 055, it notifies the destination home agent #2 of the deletion completion of the BC transmission signal 055.

In this manner, in selecting the MNs #1 to #3, each of the home agents #1 to #n can make a flexible selection according to a load on each of destination home agents #1 to #n other than itself which is to be selected.

Therefore, a particular home agent #i is prevented from failing due to an increase in load, and a stable communications environment is assured.

(2-13) Message Exchange in BC Transfer

FIG. 14 is a flowchart for explaining the process of transferring a BC 001 after the determination of a destination home agent according to the embodiment of the present invention. The BC transmission control section 203 of the source home agent #1 shown in the figure transfers a BC transmission signal 055 containing the determined transfer BCs 600, 601, and 602 to the destination home agent #2 (step C1). The state of each of the transfer BCs 600, 601, and 602 is set to “under transfer” (step C2).

On the other hand, if the BC reception control section 204 of the destination home agent #2 receives the BC transmission signal 055 (step C7), it extracts the transfer BCs 600, 601, and 602. The state of each of the transfer BCs 600, 601, and 602 is set to “under reception” (step C8). The transfer BCs 600, 601, and 602 are registered as the BC 001 of the destination home agent itself. The BC reception control section 204 of the destination home agent #2 transmits a BC reception OK signal 056 to the source home agent #1 (step C9).

If the BC transmission control section 203 of the source home agent #1 receives the BC reception OK signal 056 (step C3), it deletes the transfer BCs 600, 601, and 602 (step C4) and transmits a BC deletion notification signal 057 to the destination home agent #2 (step C5).

The BC reception control section 204 of the destination home agent #2 receives the BC deletion notification signal 057 (step C10) and sets the state of the registered transfer BCs 600, 601, and 602 to “after transfer” (step C11). The BC reception control section 204 also transmits a BC transfer completion signal 058 to the source home agent #1 (step C12).

Here, if the BC transmission control section 203 of the source home agent #1 receives the BC transfer completion signal 058, it finishes the transfer process (step C6).

If the life time of a binding cache (BC) is approaching close to the time limit, the BC reception control section 204 of the destination home agent #2 transmits a binding request (BR) to the MNs #1 to #3 having the care-of address of the transfer BCs 600, 601, and 602 (step C13). When the BC reception control section 204 does not receive a response signal for a fixed time (see a triangle shown in FIG. 14), it notifies the MNs #1 to #n of refreshing of a home agent (refreshing of a binding cache) and sets the state of each of the transfer BCs 600, 601, and 602 to “normal” (step C14).

Therefore, at the time of BC transfer, the source home agent #1 and the destination home agent #2 both change the “state” while holding a binding cache, and control a tunneling process. And after confirming that transfer is successful, the source home agent #1 deletes the BC held by the agent #1 itself.

In this way, when the home agent #1 for the MN #1 is switched to the home agent #2, the communication shut-off time between the CN #1 and the MN #1 is suppressed.

Note that the processing procedure in the source agent #1 includes generating a header, which contains the address of the home agent #1 itself and addresses of other home agents #2 to #n. Also, the processing procedure in the destination home agents #2 to #n includes extracting source and destination addresses from packets transmitted from other home agents #2 to #n and holding the extracted data.

(3) Data Holding Section 300

The data holding section 300 is memory for holding care-of addresses and load information and has a BC 001, BC load information 002, and home agent load information 003.

(3-1) BC 001

The data held in a BC 001 will be described with reference to FIG. 7A to 7C.

FIG. 7A is a diagram for explaining the region of a BC 001 according to the embodiment of the present invention. The region of a BC 001 shown in the figure has regions BC1 to BC5 assigned to five MNs including the MNs #1 to #3. Each of the regions BC1 to BC5 has an existing conversion table (not shown) in which a home address and a care-of address are related to each other, and also holds conversion data recorded on this conversion table and the transferred state (hereinafter referred to as a “state”) of each conversion data.

This “state” represents the processed state of a BC 001 exchanged (transmitted and received) between the home agent #1 and other home agents #2 to #n and represents, for example, “under transfer,” “under reception,” “after transfer,” and “normal.”

Here, the state “under transfer” represents the state in which a BC 001 is now being transferred.

The state of “under reception” represents the state in which, for a BC 001 that the home agent #1 received from other home agents #2 to #n, the BC 001 received by the home agents #2 to #n is not yet deleted. When destination home agent #2 receives a BC deletion notification signal transmitted from the source home agent #1, it is judged that the BC 001 has been deleted.

The state of “after transfer” is the state immediately after the home agent #1 has completed the reception of the BC 001 transmitted from each of the home agents #2 to #n. And in the case where the state of the BC 001 is “after transfer,” the transfer BC 001 cannot be selected for a fixed period of time after the transfer of the BC 001 by the BC selection control section 201.

Therefore, the same BC data is prevented from being frequently selected and the home agent #1 to which the MN #1 belongs is prevented from being frequently switched. In other words, the MN #1 representing a binding cache (which is a transfer ring object) can maintain stable communications, because unnecessary switching of the home agent #1 (which is a connecting object) is prevented.

The state of “normal” is the state in which a BC 001 is not a transferring object. It is also the state other than the states of “under transfer,” “under reception,” and “after transfer.” That is, the state of “normal” means the same state as that prescribed in the existing IPv6 and mobile IPv6. In the state of “under transfer,” the same BC can be present in the home agents #1 to #n. In contrast to this, by defining the state of “normal,” there is no possibility that the same BC will be present in two or more home agents #1 to #n.

Therefore, the state of a BC 001 includes the state of “under transfer” in which the source home agent #1 is transferring conversion data to the destination home agent #2, the state of “under reception” in which the destination home agent #2 is holding conversion data, the state of “after transfer” in which the source home agent #1 receives a reception completion signal from the destination home agent #2, and the state of “normal.”

On the other hand, if the CNs #1 to #3 receive a response packet, they record binding data (destination information) for the MNs # 1 to #3. Based on this record, the CNs #1 to #3 communicate with desired MNs #2 and #3 directly without communicating with the home agent #1. Here, the destination of a packet from each of the CNs #1 to #3 contains the home address of the MNs # 1 to #3 and also contains the care-of address of each of the MNs # 1 to #3 with respect to a router (not shown) that forwards the packet.

In this way, packets are transferred directly to the MNs #2 and #3 without being transferred to the home agent #1, so a processing load on the home agent #1 is lightened.

Thus, a BC 001 holds location information for each of the MNs #1 to #3 that has regions BC1 to BC5 holding binding data by which five conversion data for converting a home address and a care-of address are bound to five states representative of the processed states of each conversion data.

Therefore, each of the home agents #1 to #5 converts and outputs a normal home address and a care-of address mutually and manages each conversion data by employing the state of each conversion data. Thus, since processed states are individually monitored at all times, a high-reliability transfer process becomes possible.

In addition to these, when the mobile communications system 9 develops the mobile IPv6 and supports mobile IP hierarchical addresses by employing mobile IP addresses such as mobile IPv4 addresses and mobile IPv6 addresses, data held by a BC 001 can also hold other information data for hierarchical addresses.

(3-2) Management Employing the State of a BC 001

According to the mobile IPv6, in the case of the state of “normal” there is no possibility that the same BC 001 will be held in n home agents #1 to #n. The reason is that, in the mobile communications system 9, if the same BC 001 is held in a plurality of home agents #3 to #n, these agents perform the tunneling process on the same packet and therefore the MNs #1 to #3 that receive the BC 001 receive a plurality of the same packets. That is, there is no possibility that the MNs #1 to #3 will receive a plurality of the same packets.

In other words, when the state of a BC 001 is “under transfer,” there are cases where the same BC 001 is held in the home agents #1 to #n. On the other hand, in the case of the state of “normal,” there is no possibility that the same BC 011 will be held in the home agents #1 to #n. In this case, the state is the same as that prescribed by the existing mobile IPv6.

When the state of a BC 001 is “under transfer” or “under reception,” the home agents #1 to #n respond employing the same BC 001. Here, each of the home agents #1 to #n performs the tunneling process on the BC 001 under transfer, but does not perform the tunneling process on the BC 001 under reception.

In the case of the state of “after transfer,” each of the home agents #1 to #n cannot select the BC 001 by the BC selection control section 201 of each agent, and sets the state to “normal” after a fixed time.

In this way, the same BC is prevented from being frequently selected and the home agent #1 to which the MN #1 belongs is prevented from being frequently switched.

(3-3) BC Load Information 002

BC load information 002 is a transfer quantity when the tunneling process is being performed on each BC 001. FIG. 7B is a diagram showing an example of the data held in BC load information according to the embodiment of the present invention. The BC load information 1, BC load information 2, BC load information 3, BC load information 4, and BC load information 5, shown in the figure, are held so as to correspond to the regions BC1 to BC5, and are recorded for each BC 001. Here, the load information for each of the regions BC1 to BC5 is represented by employing a history of transfer quantities shown in FIG. 7B. A history of transfer quantities for a region BC1 is obtained by recording a transfer quantity at intervals of 1 second. In the figure, a transfer quantity 1 represents the current transfer quantity, a transfer quantity 2 represents a transfer quantity 1 sec before the current transfer quantity, and a transfer quantity m (where m is a natural number) represents a transfer quantity (m-1) sec before the current transfer quantity.

The measuring interval (e.g., 1 second) for the transfer quantity is determined by a communications carrier (manager or maintenance man), based on the magnitude of a load on each of the subnetworks 10 and 62 to 64, network functions, or network installation purposes. Here, when the average value of loads is extremely low (e.g., 1 packet/sec), a communications carrier sets the measuring interval for a transfer quantity to 1 minutes. Also, when the average value of loads is 10000 packets/sec, a communications carrier judges that the measuring interval must be within 1 sec.

Therefore, the BC selection control section 201 selects, for example, 5 regions BC1 to BC5, based on a history of packet transfer quantities obtained when packets are being tunneled to the MNs #1 to #3.

And BC load information 002 acquires load information recorded on each region of a BC 001. In a method of acquiring this load information, a transfer quantity for t₁ sec is continuously recorded and each transfer quantity is held the past p₁ times (where p₁ is a natural number).

(3-4) Home Agent (HA) Load Information 003

Home agent load information 003 is the load information of each of the home agents #1 to #n.

FIG. 7C is a diagram showing an example of the data held in home agent load information 003 according to the embodiment of the present invention. The home agent load information 003 shown in the figure has a region for recording the load information of the home agent #1 at intervals of 1 sec. The home agent load information of each home agent includes a CPU operation rate, a memory operation rate, and the unoccupied volume of a storage device such as a hard disk. That is, the HA selection control section 202 employs the home agent load information 003 in monitoring an increase in a load on a self-agent, also in judging whether a BC acceptance request signal is acceptable or unacceptable when it is received, and in calculating acceptable BC load information 002. And the source home agent #1 determines a destination home agent, based on the contents of a response to a BC acceptance request signal.

And a home agent load information collecting section 100 has data holding sections 002 and 003 for holding second load information (002 and 003), and the acceptance judging section 103 judges whether a BC acceptance request signal 051 is acceptable, based on the second load information (002 and 003) held in the data holding sections 002 and 003.

Home agent load information 003 measures the load information of the home agent #1 itself at intervals of t₂ sec and holds it the past p₂ times (where p₂ is a natural number).

Thus, the data held in a BC 001 has the BC 001 of each of the MNs #1 to #3, data prescribed by the existing mobile IPv4 and mobile IPv6, and the state of a BC 001 used when transferring the BC 001.

Even when the loads on the home agents #1 to #n increase and there is a possibility of some of the home agents failing, each of the home agents #1 to #n can transfer all BCs 001 held in itself to other home agents #1 to # (n-1) other than itself.

In this manner, packet-processing delay and packet loss are avoided.

(4) Signal Format

The signals between home agents will be described with reference to FIGS. 2, 8A, 8B, and 11.

(4-1) BC Acceptance Request Signal 051

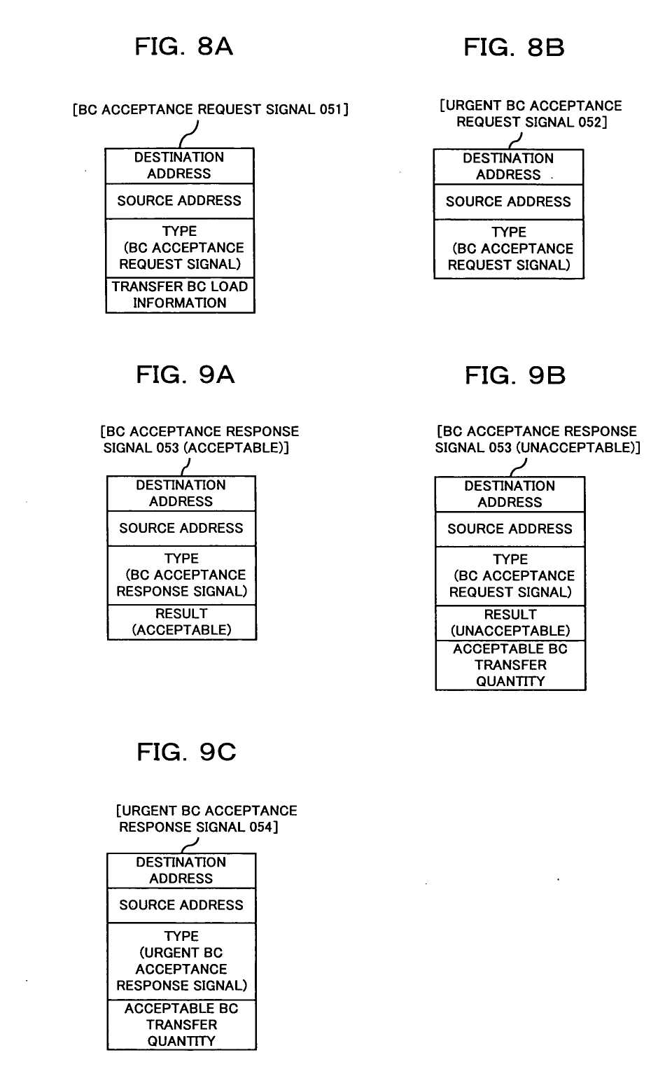

FIG. 8A is a diagram showing the format of the BC acceptance request signal 051 according to the embodiment of the present invention. The BC acceptance request signal 051 shown in the figure is transmitted by the HA selection control section (first home agent selection control section) 202 of the home agent #1 and is received by the HA selection control section (second home agent selection control section) 202 of the home agent #2. More specifically, for example, the home agent #1 that has increased in load transmits the BC acceptance request signal 051 containing the BC load information 002 requesting the processing of some of the BCs 001 of the home agent #1 itself in order to determine a destination home agent of the home agents #2 to #n.

The destination address shown in FIG. 8A is the address of a destination home agent to which the BC acceptance request signal 051 is to be transmitted. Also, the source address shown in the figure is the address of a source home agent that has transmitted the BC acceptance request signal 051. The type shown in the figure is information representing the signal type transmitted. With this signal type, a destination home agent can recognize that the received signal type is the BC acceptance request signal 051. The transfer BC load information is the BC load information 002 of a BC 001 requested to be transferred.

(4-1) Urgent BC Acceptance Request Signal 052

FIG. 8B is a diagram showing the format of an urgent BC acceptance request signal 052 according to the embodiment of the present invention. For example, when the home agent #1 judges that it cannot continue to provide communication services, it transmits an urgent BC acceptance request signal 052 shown in FIG. 8B to ask each of the home agents #2 to #n about an acceptable transfer quantity.

The destination address shown in the figure is the address of a destination home agent to which the urgent BC acceptance request signal 052 is to be transmitted. Also, the source address shown in the figure is the address of a source home agent that has transmitted the urgent BC acceptance request signal 052. The type shown in the figure represents the urgent BC acceptance request signal 052 transmitted.

(4-3) BC Acceptance Response Signal 053

FIGS. 9A and 9B are diagrams showing the formats of a BC acceptance response signal 053 according to the embodiment of the present invention and show acceptable and unacceptable cases for a BC 001. This BC acceptance response signal 053 is transmitted by the HA selection control section 202 of a BC source candidate and is received by the HA selection control section 202 of a BC destination candidate.

More specifically, if each of the home agents #2 to #n receives a BC acceptance request signal 051 (see FIG. 8A), each home agent judges whether the BC 001 is acceptable or unacceptable, employing both the HA load information 003 of the home agent and the transfer BC load information contained in the BC acceptance request signal 051. When the result of the judgment is “acceptable,” data representative of “acceptable” is written to the BC acceptance response signal 053 shown in FIG. 9A.

Also, when it is “unacceptable,” an acceptable BC transfer quantity that each of home agents #2 to #n can accept is also written to the BC acceptance response signal 053.

Here, the “destination address” is the address of a destination home agent to which the BC acceptance response signal 053 is to be transmitted. Also, the “source address” is the address of a source home agent that has transmitted the BC acceptance response signal 053. The “type” represents the signal type transmitted. The “result” represents whether the requested BC 001 is acceptable or unacceptable. The “acceptable BC transfer quantity” is information about an acceptable BC transfer quantity that each of other home agents can accept. This transfer quantity is contained only when the result is “unacceptable.”

(4) Urgent BC Acceptance Response Signal 054

FIG. 9C is a diagram showing the format of an urgent BC acceptance response signal 054 according to the embodiment of the present invention. The urgent BC acceptance response signal 054 is transmitted by the HA selection control section 202 and is received by the HA selection control section 202. More specifically, if each of the home agents #2 to #n receives an urgent BC acceptance request signal 052, an urgent BC acceptance response signal 054 containing an acceptable maximum BC transfer quantity obtained from the HA load information 003 is transmitted.

Here, the “destination address” is the address of a destination home agent to which the urgent BC acceptance response signal 054 is to be transmitted. Also, the “source address” is the address of a source home agent that has transmitted the urgent BC acceptance response signal 054. The “type” represents the signal type transmitted. The “acceptable BC transfer quantity” is information about an acceptable BC transfer quantity that each of other home agents can accept.

(4-5) BC Transmission Signal 055

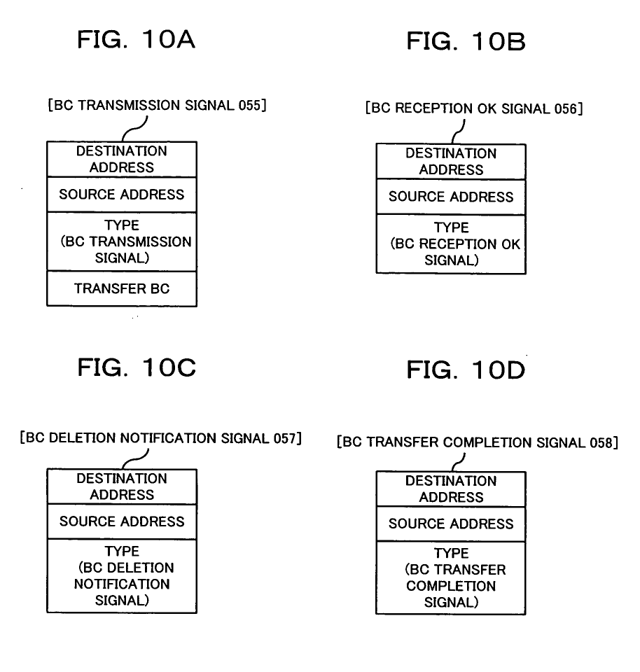

FIG. 10A is a diagram showing the format of a BC transmission signal 055 according to the embodiment of the present invention. The BC transmission signal 055 shown in the figure contains a BC 001 having information data that is to be transferred to a destination home agent. The BC transmission signal 055 is transmitted by the BC transmission control section 203 and is received by the BC reception control section 204.

The “destination address” is the address of a destination home agent to which the BC transmission signal 055 is to be transmitted. Also, the “source address” is the address of a source home agent that has transmitted this signal. The “type” represents the BC transmission signal 055.

(4-6) BC Reception Confirmation Signal (Reception OK Signal) 056

FIG. 10B is a diagram showing the format of a BC reception confirmation signal 056 according to the embodiment of the present invention. The BC reception confirmation signal 056 shown in the figure is transmitted in response to the BC transmission signal 055 by each of the home agents #2 to #n. The BC reception confirmation signal 056 is transmitted by the BC reception control section 204 and is received by the BC transmission control section 203.

The “destination address” is the address of a destination home agent to which the BC reception confirmation signal 056 is to be transmitted. Also, the “source address” is the address of a source home agent that has transmitted this signal. The “type” represents the signal type transmitted.

(4-7) BC Deletion Notification Signal 057

FIG. 10C is a diagram showing the format of a BC deletion notification signal 057 according to the embodiment of the present invention. The BC deletion notification signal 057 shown in the figure is used to notify a destination side of the deletion of the BC 001 transmitted by the BC transmitting side. The BC deletion notification signal 057 is transmitted by the BC transmission control section 203 and is received by the BC reception control section 204.

The “destination address” is the address of a destination home agent to which the BC deletion notification signal 057 is to be transmitted. Also, the “source address” is the address of a source home agent that has transmitted this signal. The “type” represents the signal type transmitted.

(4-8) BC Transfer Completion Signal 058

FIG. 10D is a diagram showing the format of a BC transfer completion signal 058 according to the embodiment of the present invention. In response to the BC deletion notification signal 057, the BC transfer completion signal 058 shown in the figure is used to notify that the received BC 001 has been made valid. The BC transfer completion signal 058 is transmitted by the BC reception control section 204 and is received by the BC transmission control section 203.

The “destination address” is the address of a destination home agent to which the BC transfer completion signal 058 is to be transmitted. Also, the “source address” is the address of a source home agent that has transmitted this signal. The “type” represents the signal type transmitted.

Therefore, the home agents communicate with each other, employing the signals shown in FIG. 8A to 10D. And n home agents can perform processing, employing a load request message and a load acceptance message.

Thus, the concentration of loads in a particular home agent is avoided and network reliability is enhanced. In addition, a maintenance man can stop a particular home agent to make maintenance easy.

(5) Home Agent #3

The home agent #3 shown in FIG. 1 has nearly the same construction as that of each of the home agents #1 and #2.

The home agent #3 includes (1) a BC 001 having a plurality of regions BC that hold binding data by which a plurality of conversion data for converting a home address and a care-of address are bound to a plurality of transferred states representative of the processed state of each conversion data; (2) a receiver section 90a for receiving a BC acceptance request signal 051 about the processing of the conversion data transmitted from the home agent #1 of the home agents #1 to #n; (3) a HA load measuring section 100 for collecting second load information (002 and 003) that comprises the HA load information 003 of the home agent #2 itself and BC load information 002 resulting from the transfer quantity of the binding data held in five regions BC holding the binding data by which conversion data (e.g., five conversion data) for converting a home address and a care-of address are bound to five states representative of the processed state of each conversion data; (4) a selecting section 200a for selecting the home agent #2 of the home agents #1 to #n and a transfer region BC of the five regions BC, based on first information (002 and 003) comprising the HA load information 003 of the home agent #1 itself and BC load information 002 that results from the transfer quantity of a packet tunneled by using the region BC; (5) an acceptance judging section 103 for judging whether a BC acceptance request signal is acceptable, based on the first load information (002 and 003) contained in the BC acceptance request signal 051 received by the receiving section 90a and the second load information (002 and 003) collected in the HA load measuring section 100; and (6) a transmitter section 90b for transmitting the transfer region BC selected in the selecting section 200a to the home agent #2 and also transmitting a registered destination change message to the MN #1.

The parts having the same reference numerals as the aforementioned parts are the same as those or have the same function.

(6) Mobile Communications System 9

The mobile communications system 9 includes a BC selection control section 201 for selecting a destination home agent #2 of n home agents #1 to #n and a BC region for transfer of a plurality of BC regions (e.g., five BC regions 1 to 5), based on a BC 001 having the five BC regions 1 to 5 that hold binding data by which a plurality of conversion data for converting a home address and a care-of address are bound to a plurality of transferred states representative of the processed state of each conversion data, and on first load information (002 and 003) comprising the home agent load information 003 of the source home agent #1 and BC load information 002 resulting from the transfer quantity of packets tunneled by employing a binding cache; and a transmitter section 90b for transmitting the BC region for transfer selected by the BC selection control section 201 to the destination home agent #2 and also transmitting a registered destination change message to the MNs #1 to #3.

In the mobile communications system 9, the second home agent #2 of the n home agents #1 to #n includes a collecting section 100 for collecting second load information (002 and 003) comprising the home agent load information 003 of the second home #2 itself and BC load information 002 that results from the transfer quantity of packets tunneled by employing BC regions 1 to 5 holding the binding data by which a plurality of conversion data for converting a home address and a care-of address are bound to a plurality of transferred state representative of the processed state of each conversion data; a receiver section 90a for receiving a BC acceptance request signal 051 about the processing of the conversion data transmitted from the first home agent #1 of the n home agents #1 to #n; and a judging section 103 for judging whether the BC acceptance request signal 051 is acceptable, based on the first load information (002 and 003) contained in the BC acceptance request signal 051 received by the receiver section 90a and the second load information (002 and 003) collected by the collecting section 100.

Therefore, when a plurality of home agents are provided, each of the home agents #1 to #n can disperse a load autonomously and the capability of each home agent can be utilized up to the maximum.

Therefore, when a great number of calls concentrate temporarily in the home agent #1, it previously recognizes that a load exceeds the capability to process BC data and transfers the BC data. Thus, the load concentration in the home agent #1 is avoided.

The avoidance of the load concentration can also prevent packet-processing delay and packet loss.

(7) Explanation of Operation

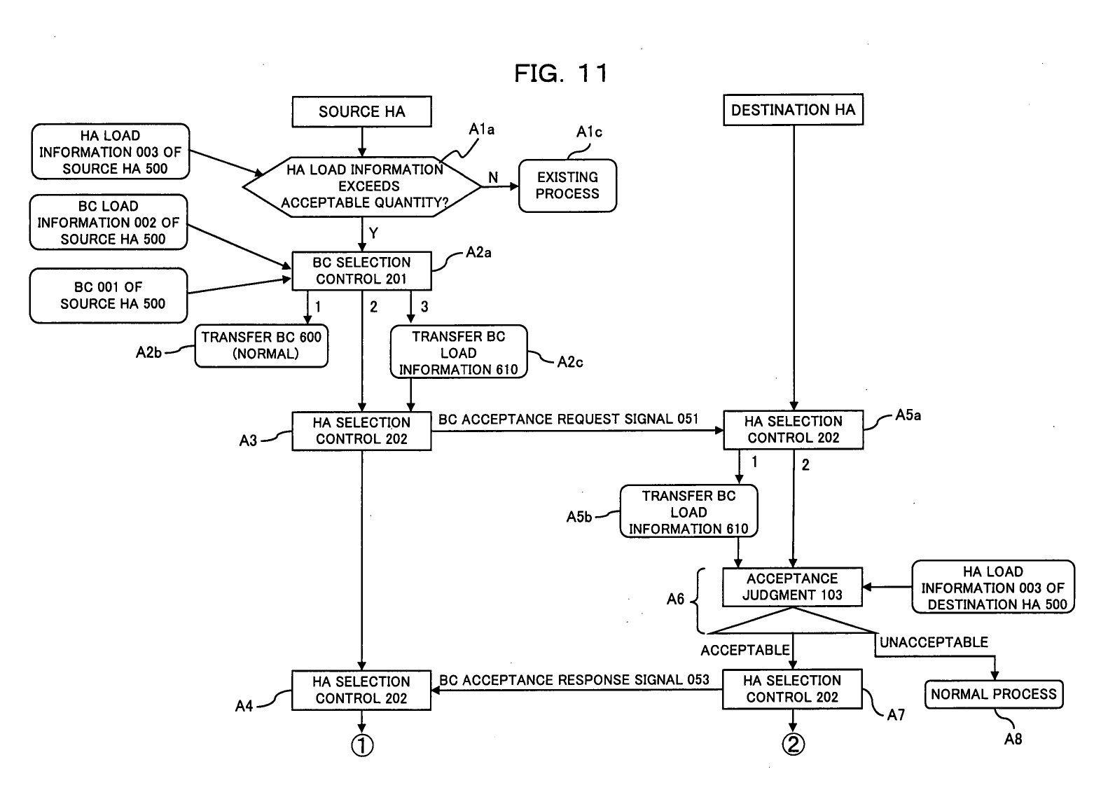

The BC selection control method according to the present invention will be described in detail with reference to FIGS. 11 to 14.

In FIGS. 11 to 13, consider the case where a load on the source home agent #1 increases and the destination home agent #2 makes a request for dispersing the load to the home agents #2 and #3 other than the home agent #1. Here, two patterns in which a load on the destination home agent #1 increases will be described.

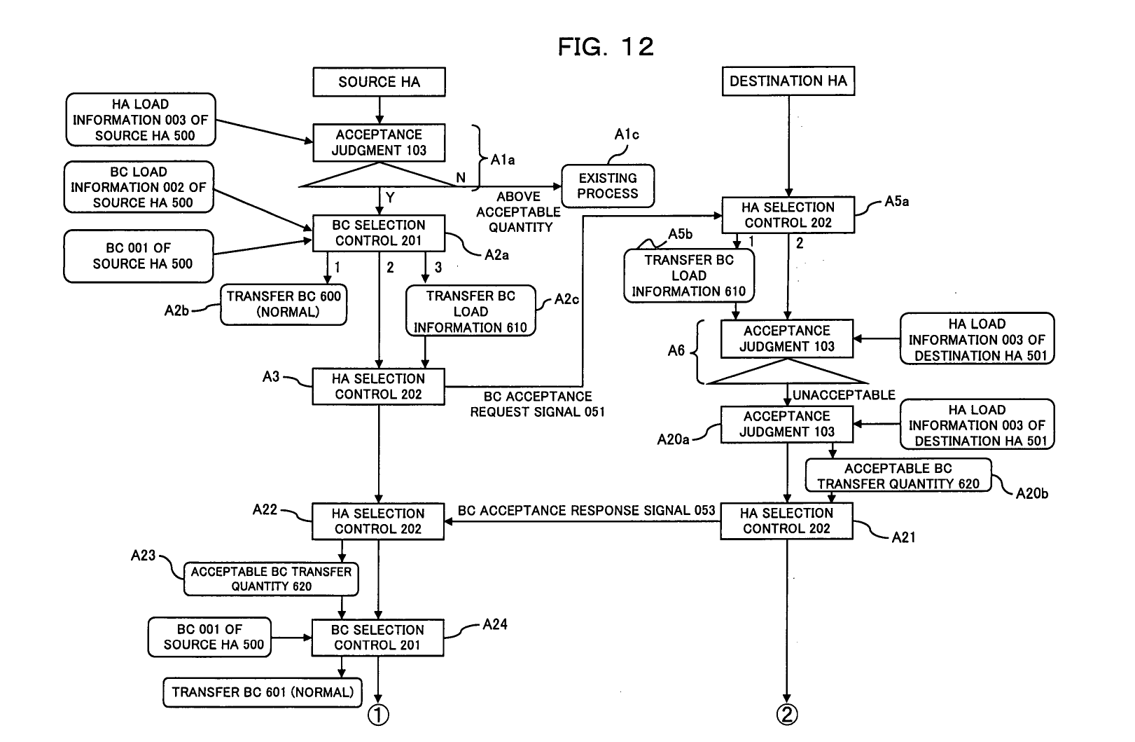

That is, in the first pattern, the source home agent #1 increases in load as it processes an increase in a tunneling process transmitted from a plurality of MNs # 1 to #3 (FIGS. 11 and 12). FIG. 11 shows the case where there is no destination home agent for processing a BC 001, while FIG. 12 shows the case where there are destination home agents.

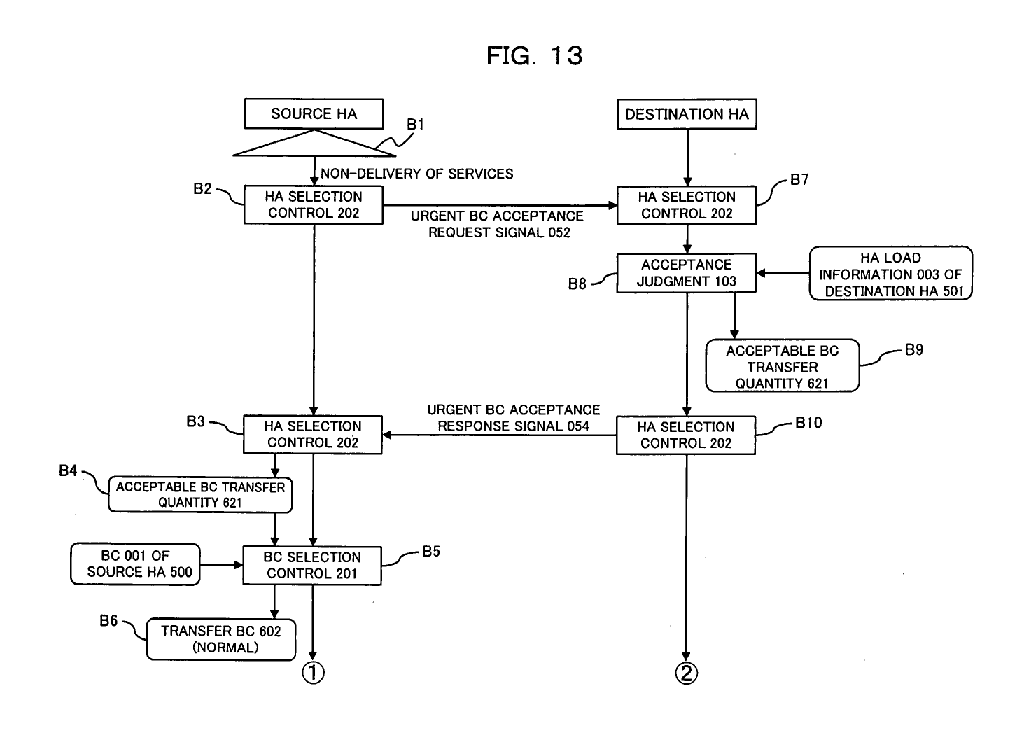

The second pattern further includes the case in which the source home agent #1 makes a request to the destination home agent #2 for a load process in case of necessity (FIG. 13).

In FIGS. 11 to 13, blocks (e.g., acceptance judgment 103) represent processing, while blocks with rounded corners (e.g., HA load information 003) represent input of data into the rounded block or output of data from the block.

(7-1) BC Transfer Control (in the Case where there are Destination Home Agents)

FIG. 11 is a flowchart for explaining a BC selection control method, according to the embodiment of the present, which is carried out when there are destination home agents. This flowchart shows the case where the process of selecting a BC 001 occurs under normal conditions because of an increase in load. In the flowchart, data is processed between a source home agent and a destination home agent.

The acceptance judging section 103 of a source home agent reads HA load information 003 and judges whether this HA load information 003 exceeds an acceptable quantity (step A1a). When it does not exceed the acceptable quantity, the acceptance judging section 103 passes along a route N and performs selection control according to the existing processing capability (step A1c). On the other hand, in step A1a, when the HA load information 003 exceeds the acceptable quantity, the BC transfer process passes along a route Y and the BC selection control section 201 reads the BC load information 002 and BC 001 in step A2a, passes along a route 1, and selects a BC 001 whose load is greatest of a plurality of BCs 001, as an ordinary transfer BC 600 (step A2b). The BC selection control section 201 passes along a route 3 and extracts and generates transfer BC load information 610 (step A2c). And BC selection control section 201 passes along a route 2 and transfers control of the transfer load information 610 to the home agent selection control section 202.

Here, the route 1 indicates that a transfer BC 600 is selected as a BC 001 for transfer in the BC selection control section 201. The route 2 indicates that processing by the home agent selection control section 202 is performed after the BC selection control section 201. The route 3 indicates that the BC selection control section 201 extracts the transfer BC load information 610 and inputs it to the home agent selection control section 202.

The home agent selection control section 202 selects and controls a BC 001, based on the BC 001 of a destination home agent (step A3). The home agent selection control section 202 transmits a BC acceptance request signal 051 contained in the transfer BC load information of the transfer BC 600 to the destination home agent #2.

On the other hand, the home agent selection control section 202 of the destination home agent #2 receives the BC acceptance request signal 051 (step A5a). Here, the home agent selection control section 202 passes along a route 1 and extracts the transfer load information 610 from the BC acceptance request signal 051 (step A5b). And the destination home agent #2 passes along a route 2, reads the extracted transfer BC load information 610 and the HA load information 003 of the home agent #1, and judges acceptance (step A6). Note that a triangle in step A6 represents a branching process.

In step A6, the acceptance judging section 103 judges whether processing of the BC 001 is acceptable, based on the HA load information 003. The acceptance judging section 103 outputs the result of the judgment. When the result of the judgment is “acceptable,” it passes along a route labeled “Acceptable.” In step A7, the home agent selection control section 202 transmits a BC acceptance response signal 053 representative of “acceptable” to the source home agent #1. After the signal transmission in step A7, the destination home agent #2 starts the process of accepting transfer of the BC 001 (see \mathring{2}).

On the other hand, the home agent selection control section 202 of the source home agent #1 receives the BC acceptance response signal 053. When there are destination home agents that transmitted the BC acceptance response signal 053, the home agent selection control section 202 selects a suitable destination home agent from them. The home agent selection control section 202 also determines a combination of the transfer BC 600 and destination home agent #2 (step A4). If this step A4 is completed, the home agent #1 starts the process of transferring the BC 001 (see \mathring{1}).

In step A6, when the result of the judgment is “unacceptable,” the acceptance judging section 103 transmits a signal representative of “unacceptable” to the source home agent (step A8). Note that in step A3, the home agent selection control section 202 controls selection of a home agent.

Thus, the BS transfer control section 200 performs various controls for transferring a BC 001 to other home agents and also performs various controls for accepting a BC 001 transmitted from each of the other home agents.

(7-2) BC Transfer Control (in the Case where there is No Destination Home Agent)

FIG. 12 is a flowchart for explaining a BC selection control method, according to the embodiment of the present, which is carried out when there is no destination home agent. This flowchart shows the case in which the process of selecting a BC 001 occurs under normal conditions because of an increase in load. In FIG. 12, the same steps as those shown in FIG. 11 are given the same reference numerals.

In the acceptance judgment process in step A6 shown in FIG. 12, when the result of the judgment is “unacceptable,” the acceptance judging section 103 reads HA load information 003 in step A20a and calculates an acceptable BC transfer quantity 620 in step A20b. In step A21, the home agent selection control section 202 transmits a BC acceptance response signal 053, which contains both “unacceptable” and the calculated acceptable BC transfer quantity 620, to the source home agent #1.

On the other hand, the home agent selection control section 202 of the source home agent #1 receives the BC acceptance response signal 053 (step A22). When there is no destination home agent that transmitted “acceptable,” the BC selection control section 201 refers to each acceptable BC transfer quantity contained in the BC acceptance response signal 053 (step A23). In step A24, the BC selection control section 201 selects a combination of the most suitable destination home agent #2 and a transfer BC 600 extracted from a new BC 001.

Thus, the BC transfer control method is performed when there are destination home agents and when there is no destination home agent.

Note that the part given \mathring{1} after the aforementioned step A23 of the source home agent #1, and the part given \mathring{2} after the aforementioned step A21 of the destination home agent #2, represent the process of accepting the transfer of a BC 001.

Thus, when a great number of people visit a particular structure, or when a great number of people concentrate in a particular place, a large quantity of tunneling due to a large quantity of data communication can be prevented.

Therefore, by causing n home agents to cooperate with each other, the congestion of a particular home agent is avoided. As a result, each user can utilize stable communication lines at all times and the reliability of communication lines is enhanced.

(7-3) Load Dispersion Method of the Present Invention

The load dispersion method of the present invention is a dispersion method between n home agents #1 to #n that intercept a first packet with a home address representative of the home of the MNs #1 to #3 and transfer a second packet with a care-of address related to the home address of the MNs #1 to #3.

In the source home agent #1 of the home agents #1 to #n, the acceptance judging section 103 detects an excess of the HA load information of the source home agent #1 over an acceptable quantity (excess detection step). If the aforementioned excess is detected in the excess detection step, the HA selection control section 202 of the source home agent #1 selects a destination home agent #2 and a region BC for transfer of a plurality of regions BC holding binding data, based on first load information (002 and 003) comprising the HA load information of the home agent #1 itself and BC load information that occurs when a tunneling process is performed by employing a binding cache (selection step). And the HS selection control section 202 transmits a BC acceptance request signal to the destination home agent #2 (transmission step).

In the destination home agent #2, the HA selection control section 202 of the destination home agent #2 extracts BC load information for transfer from the BC acceptance request signal transmitted in the transmission step (extraction step). The acceptance judging section 103 judges acceptance, based on the extracted BC load information and the HA load information of the source home agent #1 itself (acceptance judgment step).

And when the judgment in the acceptance judgment step is “acceptable,” the HA selection control section 202 transmits a BC acceptance response signal 053 to the source home agent #1 (response signal transmission step).

On the other hand, in the source home agent #1, if the BC acceptance response signal 053 transmitted in the response signal transmission step is received, the HA selection control section 202 transfers a binding cache (BC) to the destination home agent #2 (transfer step).

Thus, load dispersion is performed. And a detailed description will be given of the message transmission and reception between the home agents #1 and #2.

In a load information method of the present invention, the transmission control section 203 in the source home agent #1 transfers a BC transmission signal to the destination home agent #2 and sets the state of each BC for transfer (state set step).

Subsequently, the reception control section 204 in the destination home agent #2 registers the transfer BC contained in the BC transmission signal 055, also changes the state of the transfer BC to one state of a plurality of states of the transfer BC (state change step), and transmits a BC acceptance response signal to the source home agent #1 (response signal transmission step).

And the transmission control section 203 in the source home agent #1 receives the response signal (response signal reception step) and deletes one or a plurality of transfer BCs (deletion step).

Also, the reception control section 204 in the source home agent #1 receives a confirmation response signal for the deletion performed in the deletion step (response reception step).

(7-4) Transfer BC Selection in Case of Necessity

FIG. 13 is a flowchart for explaining a BC selection method, according to the embodiment of the present, which is carried out in case of necessity. The source home agent #1 shown in the figure judges whether it can continue to provide services (see the triangular part in step B1). When it is difficult to continue to provide services (step B1), the HA selection control section 202 transmits an urgent BC acceptance request signal 052 to the destination home agent #2 (step B2).

If the HA selection control section 202 of the destination home agent #2 receives the urgent BC acceptance request signal 052 (step B7), the acceptance judging section 103 reads the HA load information 003 of the destination home agent #2 itself (step B8) and calculates a acceptable maximum BC transfer quantity 621 (step B9). The HA selection control section 202 transmits an urgent BC acceptance response signal 054 containing the acceptable maximum BC transfer quantity 621 to the source home agent #1 (step B10).

On the other hand, if the HA selection control section 202 of the source home agent #1 receives the urgent BC acceptance response signal 054 (step B3), it refers to the acceptable BC transfer quantity contained in the response signal 054 (step B4). The BC selection control section 201 refers to a BC 001 (step B5) and, based on this transfer quantity, determines a combination of a transfer BC 602 and a destination home agent #2 (step B6)

Note that if the aforementioned steps B5 and B10 shown in FIG. 13 are finished, the process of transferring a BC 001, shown in FIG. 14, is started (see \mathring{1} and \mathring{2} shown in the flowchart).

Thus, even in case of necessity, a transfer BC 001 can be reliably selected. In addition, since each home agent has an urgent processing function beforehand, the stability of communication lines is further enhanced.

(7-5) Transfer of a BC 001 to a Destination Home Agent

Since the BC-001 transfer process in the parts \mathring{1} and \mathring{2} shown in FIGS. 11 to 13 is performed according to the flowchart shown in FIG. 14, a detailed description of that process is omitted for avoiding redundancy.

Thus, the load dispersion method of the present invention changes the state of a BC and controls tunneling, during BC transfer, with the BC held by both the source home agent #1 and the destination home agent #2. And the source home agent #1 confirms that transfer is successful and then deletes the BC held by the home agent #1 itself.

Therefore, when the home agent #1 for the MN #1 is switched to the home agent #2, the communication shut-off time between the source home agent #1 and the source home agent #2 is suppressed.

In a conventional load dispersion method, after the source home agent #1 deletes a BC for transfer at the time of the BC transfer, the held BC is transferred to the destination home agent #2. Therefore, when the home agent #1 is switched to the home agent #2, communications is prevented from being shut off.

(8) Examples of Advantages of the Invention

In the technique described in the aforementioned patent document 1, when a correspondent node (CN) transmits packets to an MN, the packets have to pass through a home agent in which the MN is registered and in this home agent the packets must be encapsulated. For this reason, there are cases where a load on the home agent will increase.

In the present invention, to lighten a load on a home agent, functions of the home agent are provided in a conventional router. This MN-related router can hold binding caches and encapsulate packets that are be transmitted. Therefore, packets from the source node #1 to an MN are capsulated in an MN-related router and transmitted to the MN. Thus, a load on each home agent can be lightened.

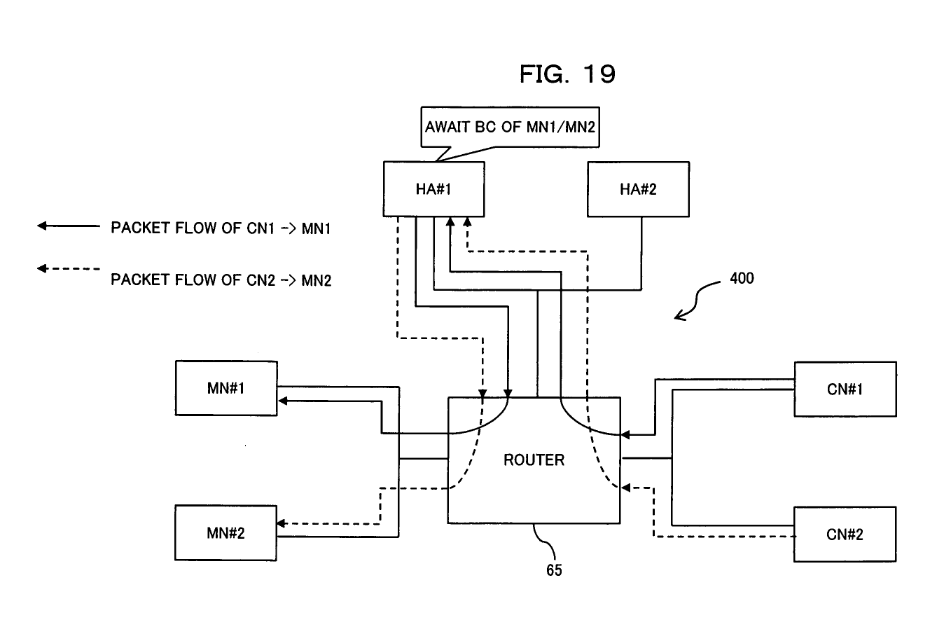

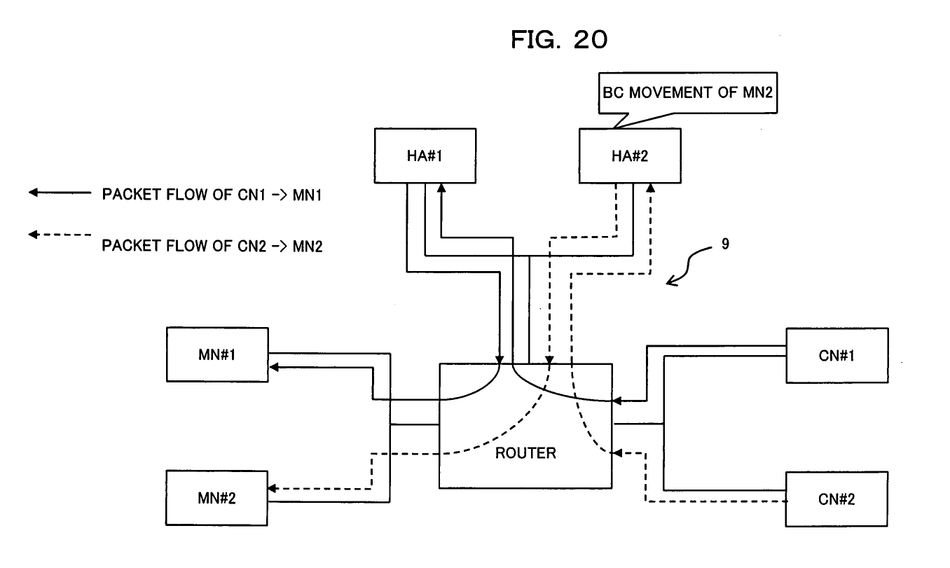

The difference between the mobile communications system 9 of the present invention and a conventional mobile communications system 400 will be described with reference to FIGS. 19 and 20. In the figures, the parts given the same reference numerals as the aforementioned parts are the same in function as the aforementioned parts, so a description of the same parts is omitted.

FIG. 19 is a diagram for explaining a method of transferring packets according to a conventional communications system 400. The home agent (HA) #1 of the home agents #1 and #2 shown in the figure has mobile nodes (MNs) #1 and #2 registered therein and waits to receive BCs from MNs #1 and #2. Packets to the MNs #1 and #2 are all encapsulated in the home agent #1.

For that reason, in order to lighten a load on each home agent, the mobile communications system 400 shown in FIG. 19 are provided with two home agents #1 and #2 so that a load on each of the MNs #1 and #2 registered is dispersed.

Here, when both the MNs #1 and #2 are registered for location information, packets to the MNs #1 and #2 are all encapsulated in the home agent #1. For that reason, a load concentrates in only the home agent #1 and the home agent #2 hardly operates.

Therefore, the home agent #1 must process a greater load than the home agent #2. That is, a load concentrates in only the home agent #1, and the home agent #2 is not utilized to process a load.

On the other hand, FIG. 20 is a diagram for explaining a method of transferring packets according to the embodiment of the present invention. The home agent #1 shown in the figure causes the home agent #2 to move or transfer a BC for the MN #2 of a plurality of BCs registered. In addition, the MN #2 is managed by the home agent #2. Therefore, a load on each home agent is dispersed.

In the present invention, a BC holding quantity of each of the home agents #1 to #n is determined so that each home agent does not hold too many BCs that can be the cause of a load on each of the home agents #1 to #n.

For that reason, the function of transferring BCs between the home agents #1 to #n is provided.

In addition, each of the home agents #1 to #n can disperse a load autonomously and the capability of each home agent can be used up to the maximum.

(B) Other Embodiments

While the present invention has been described with reference to the preferred embodiment thereof, the invention is not to be limited to the details given herein, but may be modified within the scope of the invention hereinafter claimed.

For example, the mobile communications system 9 can employ a mobile protocol which is an improvement on the mobile IPv6, or a mobile protocol having upward compatibility with the IPv6, in addition to the mobile IPv4 and mobile IPv6.

Each network can employ a network that provides high-quality transfer services capable of virtually transferring packets by giving labels to them.

The urgent BC acceptance request signal is set so that it has high priority. This priority may comprise a plurality of levels. In other words, when the priority of the BC acceptance request signal 051 received in the receiver section 90a is high, the acceptance judging section 103 may calculate an acceptable packet transfer quantity, based on BC load information 002.

Therefore, each of the home agents #1 to #n can take an urgent counter measure and judge by self-diagnosis that operation is unstable. Thus, reliable communications can be assured.

The home agent function of the present invention can also be provided in the routers 65. That is, each router 65 can be provided with the home agent function.

Therefore, the router (65) of the present invention may be a router (65) with the function of intercepting a first packet with a home address representative of the home of a mobile node (#1 to #3) and transferring a second packet with a care-of address related to the home address to the mobile node (#1 to #3). The router (65) may include: (1) a first holding section having a plurality of regions BC that hold binding data by which a plurality of conversion data for converting the home address and the care-of address are bound to a plurality of transferred states representative of a processed state of each conversion data; (2) a selecting section (200a) for selecting both a second home agent (#2) of the plurality of home agents (#1 to #n) and a region BC for transfer of the plurality of regions BC, based on first load information (002, 003) comprising home agent load information (003) of the first home agent (#1) itself and binding cache load information (002) arising when a tunneling process is performed by using a binding cache; and (3) a transmitter section (90b) for transmitting the region BC for transfer selected in the selecting section (200a) to the second home agent (#2) and also transmitting a registered destination change notification to the mobile node (#1 to #3).

Furthermore, the router (65) of the present invention may include: (1) a first holding section having the function of intercepting a first packet with a home address representative of the home of a mobile node (#1 to #3) and transferring a second packet with a care-of address related to the home address to the mobile node (#1 to #3); (2) a collecting section (100) for collecting second load information (002, 003) comprising home agent load information (003) of the second home agent (#2) itself and binding cache load information (002) arising when a tunneling process is performed by using a binding cache; (3) a receiver section (90a) for receiving a dispersion process request (051) for processing conversion data transmitted from a first home agent (#1) of the plurality of home agents (#1 to #n); and (4) a judging section (103) for judging whether the dispersion process request (051) is acceptable, based on first load information (002, 003) contained in the dispersion process request (051) received in the receiver section (90a) and the second load information (002, 003) collected by the collecting section (100).

As set forth in detail, the home agent, mobile communications system, load dispersion method of the present invention are capable of effectively utilizing the resource of each home agent and achieving cost reduction. In addition, a load on each home agent is dispersed, the performance of each home agent is maintained, and the capability of each home agent is used up to the maximum. Thus, network performance can be enhanced.

1. A first home agent of a plurality of home agents each for intercepting a first packet with a home address representative of the home of a mobile node and transferring toward the mobile node a second packet with a care-of address associated with the home address, said first home agent comprising:
a first holding section having a plurality of regional BCs each of which holds binding data, said binding data defining a correspondence between a plurality of conversion data pieces, each of which is obtained by converting the home address into the care-of address, and a plurality of transferred states, each of which represents a processed state of each of the conversion data pieces;
a selecting section for selecting a second home agent from the plural home agents and also selecting a regional BC for transfer from the plural regional BCs based on first load information, said first load information comprising home agent load information, which is information regarding the load of said first home agent itself, and binding cache load information, which is information regarding the load arising when a tunneling process is performed by using a binding cache; and
a transmitter section for transmitting the regional BC for transfer, selected in said selecting section, toward the second home agent and also transmitting a registered destination change notification toward the mobile node.

2. The home agent as set forth in claim 1, wherein said selecting section comprises:
a binding cache selection control section for selecting the regional BC for transfer based on the binding cache load information; and
a home agent selection control section for selecting the second home agent.

3. The home agent as set forth in claim 2, wherein said binding cache selection control section is operable to select the regional BC for transfer based on a history of packet transmission quantities calculated when the second packet is being tunneled to the mobile node.

4. The home agent as set forth in claim 2, wherein said home agent selection control section is operable to use the home agent load information for monitoring an increase in a load on a self-agent, for judging whether a binding cache acceptance request signal is acceptable or unacceptable when it is received, and for calculating acceptable binding cache load information.

5. The home agent as set forth in claim 2, wherein said home agent selection control section is operable to select the second home agent based on a return signal transmitted from the second home agent toward said first home agent in response to a dispersion process request transmitted by said first home agent, which request contains the regional BC for transfer.

6. The home agent as set forth in claim 1, wherein the transferred states in said first holding section includes at least: a state of “under transfer”, which designates the state where said first home agent is transmitting the conversion data pieces toward the second home agent; a state of “under reception”, which designates the state where the second home agent is holding the conversion data pieces; a state of “after transmission”, which designates the state where said first home agent receives completion of reception from the second home agent; and a normal state.

7. A second home agent of a plurality of home agents each for intercepting a first packet with a home address representative of the home of a mobile node and transferring toward the mobile node a second packet with a care-of address associated with the home address, said second home agent comprising:
a collecting section for collecting second load information, said second load information comprising home agent load information, which is information regarding the load of said second home agent itself, and binding cache load information, which is information regarding the load arising when a tunneling process is performed by using a binding cache;
a receiver section for receiving a dispersion process request to process conversion data transmitted from a first home agent of the plural home agents; and
a judging section for judging whether the dispersion process request is acceptable, based on both first load information, which is contained in the dispersion process request received in said receiver section, and the second load information, which is collected by said collecting section.

8. The home agent as set forth in claim 7, wherein
said collecting section comprises a data holding section for holding the second load information, and
said judging section is operable to judge whether the dispersion process request is acceptable, based on the second load information held in said data holding section.

9. The home agent as set forth in claim 8, wherein when the dispersion process request received by said receiver section has high priority, said judging section is operable to calculate an acceptable packet transfer quantity based on the binding cache load information.

10. A third home agent of a plurality of home agents each for intercepting a first packet with a home address representative of the home of a mobile node and transferring toward the mobile node a second packet with a care-of address associated with the home address, said third home agent comprising:
a first holding section having a plurality of regional BCs each of which holds binding data, said binding data defining a correspondence between a plurality of conversion data pieces, each of which is used for converting the home address and the care-of address, and a plurality of transferred states, each of which represents a processed state of each of the conversion data pieces;
a receiver section for receiving a dispersion process request for processing the conversion data transmitted from a first home agent of the plural home agents;
a collecting section for collecting second load information, said second load information comprising home agent load information, which is information regarding the load of a second home agent of the plural home agents, and binding cache load information, which is information regarding the load arising when a tunneling process is performed by using a binding cache;
a selecting section for selecting the second home agent from the plural home agents and selecting a regional BC for transfer from the plural regional BCs, based on first load information comprising home agent load information, which is information regarding the load of the first home agent itself, and binding cache load information, which is information regarding the load arising when a tunneling process is carried out using a binding cache;
a judging section for judging whether the dispersion process request is acceptable, based on the first load information, which is contained in the dispersion process request received by said receiver section, and the second load information, which is collected by said collecting section; and
a transmitter section for transmitting the regional BC for transfer, selected in said selecting section, toward the second home agent and also transmitting a registered destination change notification to the mobile node.

11. A first home agent for intercepting a first packet with a home address representative of the home of a mobile node and transferring toward the mobile node a second packet with a care-of address associated with the home address, said first home agent comprising:
a receiver section for transmitting packets toward, and receiving packets from, the mobile node or a second home agent by using a plurality of conversion data pieces, which is used for converting the home address and the care-of address;
a first holding section having a plurality of regional BCs, each of which defines a correspondence between the plural conversion data pieces and a plurality of transferred states, each of which represents a processed state of each of the conversion data pieces; and
a dispersion process accepting section for accepting a plurality of regional BCs requested by the second home agent, based on first load information, which is information regarding the load of said first home agent itself, and second load information, which is information regarding the load of the second home agent.

12. The home agent as set forth in claim 11, wherein each of said first home agent and said second home agent includes a transmitter section for controlling packet transfer by changing the transferred state while holding binding data held in the plural regional BCs.

13. A mobile communications system comprising a plurality of home agents each for intercepting a first packet with a home address representative of the home of a mobile node and transferring a second packet toward the mobile node with a care-of address associated with the home address, wherein:
a first home agent of said plurality of home agents comprises
a first holding section having a plurality of regional BCs that hold binding data by which a plurality of conversion data for converting said home address and said care-of address are bound to a plurality of transferred states representative of a processed state of each conversion data,
a selecting section for selecting both a second home agent of said plurality of home agents and a regional BC for transfer of the plural regional BCs, based on first load information, said first load information comprising home agent load information, which is information regarding the load of said first home agent itself, and binding cache load information, which is information regarding the load arising when a tunneling process is carried out using a binding cache, and
a transmitter section for transmitting the regional BC for transfer, selected in said selecting section, toward said second home agent and also transmitting a registered destination change notification to said mobile node; and
said second home agent of said plurality of home agents comprises
a collecting section for collecting second load information comprising home agent load information of said second home agent itself and binding cache load information arising when a tunneling process is performed by using a binding cache,
a receiver section for receiving a dispersion process request for processing said conversion data transmitted from said first home agent of said plurality of home agents, and
a judging section for judging whether the dispersion process request is acceptable, based on the first load information, which is contained in the dispersion process request received by said receiver section, and the second load information, which is collected by said collecting section.

14. A method of dispersing a load between a plurality of home agents each for intercepting a first packet with a home address representative of the home of a mobile node and transferring to the mobile node a second packet with a care-of address associated with the home address, said method comprising:
in a first home agent of the plural home agents,
an excess detection step, carried out by a first judging section, of detecting an excess of the home agent load information of said first home agent over an acceptable quantity;
a selection step, carried out by a selection section when the excess is detected in said excess detection step, of selecting a second home agent from the plural home agents and selecting a regional BC for transfer from a plurality of regional BCs each of which holds binding data, based on first load information, said first load information comprising home agent load information, which is information regarding the load of said first home agent itself, and binding cache load information, which is information regarding the load arising when a tunneling process is carried out using a binding cache; and
a transmission step, carried out by a first home agent selection control section, of transmitting an acceptance request signal to said second home agent;
in said second home agent,
an extraction step, carried out by a second home agent selection control section, of extracting binding cache load information for transfer from said acceptance request transmitted in said transmission step, and
an acceptance judgment step, carried out by a second judging section, of judging acceptance based on the extracted binding cache load information and the home agent load information of said first home agent;
a response signal transmission step, carried out by said second home agent selection when the judgment in said acceptance judgment step is “acceptable”, of transmitting a binding cache acceptance response signal to said first home agent; and
in said first home agent,
a transfer step, carried out by said first home agent control selection when said binding cache acceptance response signal transmitted in said response signal transmission step is received, of transferring a binding cache to said second home agent.

15. The method as set forth in claim 14, further comprising:
in said first home agent,
a state set step, carried out by a transmission control section, of transferring a binding cache transmission signal to said second home agent and setting each state of each binding cache for transfer;
in said second home agent,
a state change step, carried out by a reception control section, of registering a transfer binding cache contained in a binding cache transmission signal and changing a state of said transfer binding cache to one state of a plurality of states of said transfer binding cache; and
a response signal transmission step of transmitting a binding cache acceptance response signal to said first home agent;
in said first home agent,
a response signal reception step, carried out by said transmission control section, of receiving said binding cache acceptance response signal and a deletion step of deleting one or a plurality of transfer binding caches; and
in said second home agent,
a response reception step, carried out by said reception control section, of receiving a confirmation response for the deletion performed in said deletion step.
